(19) United States
(12) Patent Application Publication
(10) Pub. No.: US 2015/0085217 A1
(43) Pub. Date: Mar. 26, 2015

(54) RETARDATION FILM, PROCESS FOR PRODUCING POLARIZER, AND LIQUID-CRYSTAL DISPLAY DEVICE

(71) Applicant: Konica Minolta, Inc., Tokyo (JP)

(72) Inventors: Takashi Nanjo, Tokyo (JP); Masumi Nishimura, Tokyo (JP); Kazuki Akasaka, Tokyo (JP); Takahiro Takagi, Tokyo (JP); Takashi Murakami, Tokyo (JP)

(21) Appl. No.: 14/398,349

(22) PCT Filed: May 1, 2012
(86) PCT No.: PCT/JP2012/002943

§ 371 Date: Oct. 31, 2014

(51) Int. Cl. G02F 1/13363; G02B 1/08; G02B 5/30; G02F 1/1368; G02F 1/1335

(52) U.S. Cl. CPC G02F 1/13363; G02F 1/1368; G02F 1/133528; G02F 1/133514; G02B 5/3083; G02B 1/08; G02B 5/305
USPC 349/42; 359/489.07; 427/163.1; 252/585

(57) ABSTRACT

The purpose of the present invention is to provide a retardation film which includes cellulose acetate having a low degree of acyl substitution and, despite this, swells very little when immersed in a saponifying solution and which has satisfactory adhesion to polarizing elements. This retardation film comprises: a cellulose ester which has a total degree of substitution with acyl groups of 2.0-2.55 and in which when log [Mw(a)] obtained through analyses by gel permeation chromatography (GPC), low angle laser light scattering (LALLS), and viscosity measurement, is plotted as abscissa and log [Iv(a)], obtained through the analyses is plotted as ordinate, the plot has a slope of 0.65-0.85; and a glass-transition-temperature lowering agent having an SP value of 9.0-11.0. The retardation film contains a solvent remaining therein in an amount of 700-3,000 mass ppm and has a change in weight through storage at 80° C. and 90% RH of −0.5 to 0.5%.

### TECHNICAL FIELD

The present invention relates to a retardation film, a method for producing a polarizing plate, and a liquid crystal display device.

### BACKGROUND ART

Liquid crystal display devices are widely used as liquid crystal displays for televisions, personal computers, and the like. Among them, a vertical alignment type liquid crystal display device is preferably used because of its high contrast.

The liquid crystal display device includes a liquid crystal cell and a pair of polarizing plates holding the liquid crystal cell therebetween. The polarizing plate includes a polarizer and a pair of protective films holding the polarizer therebetween. A retardation film (or an optical compensation film) is usually used for the protective film to be disposed on the side facing the liquid crystal cell of the polarizer.

For example, an optical compensation film which includes a cellulose acetate film and an optical anisotropic layer provided thereon and including a liquid-crystalline compound is proposed as the retardation film (see Patent Literature 1).

### CITATION LIST

### Patent Literature

### PTL 1

### Japanese Patent No. 4267191

### SUMMARY OF INVENTION

### Technical Problem

Here, films including a cellulose ester (for example, cellulose diacetate) having a low degree of substitution of acyl groups, which are likely to develop high retardation by stretching, are also preferably used as the retardation film. The retardation film including such a cellulose ester is usually subjected to saponification treatment using a saponifying solution, and thereafter the retardation film and a polarizer are pasted together with an adhesive interposed therebetween.

However, since a retardation film including cellulose acetate having a low degree of substitution of acyl groups is more hydrophilic than a film including cellulose acetate having a high degree of substitution of acyl groups, the retardation film is prone to swell when immersed in a saponifying solution. Therefore, there is a problem that an angle between a slow axis of a retardation film subjected to the saponification treatment and an absorption axis of a polarizer is prone to be deviated from a set angle (axis deviation is prone to be generated). The axis deviation between a retardation film and a polarizer causes a decrease in visibility, particularly a color shift of the vertical alignment type liquid crystal display device. Particularly, in a liquid crystal display device having a high aperture ratio, the color shift is prone to be conspicuous.

The swelling of a retardation film when immersed in a saponifying solution can be suppressed to some extent by shortening an immersion time in a saponifying solution. However, when the immersion time in the saponifying solution is short, the surface of the retardation film cannot be sufficiently subjected to the saponification treatment, which is prone to cause insufficient adhesiveness to the polarizer.

The present invention was achieved under such circumstances. An object of the present invention is to provide a retardation film which swells only a little when immersed in a saponifying solution and has good adhesiveness to a polarizer, even though the film includes cellulose acetate having a low degree of substitution of acyl groups.

### Solution to Problem

[1] A retardation film including: a cellulose ester having a total degree of substitution of acyl groups of 2.0 to 2.55 and a slope of a plot of 0.65 to 0.85, the plot being obtained by plotting a common logarithm log [Mw(a)] of an absolute molecular weight Mw(a) on an abscissa axis versus a common logarithm log [Iv(a)] of an intrinsic viscosity Iv(a) on an ordinate axis, through GPC-LALLS-viscosity measurement; and a glass-transition-temperature lowering agent having an SP value of 9.0 to 11.0, in which an amount of a residual solvent in the retardation film is 700 mass ppm to 3,000 mass ppm; and a weight change ratio represented by the following Formula:

weight change ratio (%)=(M1−M0)/M0×100

is −0.5% to 0.5%, where a weight of the retardation film before storage at 80° C. and 90% RH is defined as M0 and a weight of the retardation film after storage at 80° C. and 90% RH for 120 hours is defined as M1.

[2] The retardation film according to [1], in which all of the acyl groups included in the cellulose ester are an acetyl group.

[3] The retardation film according to [1] or [2], in which the residual solvent in the retardation film contains dichloromethane and methanol.

[4] The retardation film according to any one of [1] to [3], in which the glass-transition-temperature lowering agent is a phosphoric acid ester compound or a polyester compound.

[5] The retardation film according to any one of [1] to [4], in which a weight change ratio represented by the following Formula:

weight change ratio (%)=(M2−M0)/M0×100

is −2% to −4%, where a weight of the retardation film after storage at 80° C. and 90% RH for 300 hours is defined as M2.

[6] The retardation film according to any one of [1] to [5], in which the retardation film is a wound body wound in a direction perpendicular to a width direction of the film.

[7] A method for producing a polarizing plate including a polarizer and a retardation film according to any one of [1] to [6], in which the polarizing plate satisfies both the following Formulas (a) and (b):

40≦F≦100 (a)

6≦F/P≦16, (b)

where a thickness of the polarizer is defined as P (μm) and a thickness of the retardation film is defined as F (μm).

[8] A liquid crystal display device including: a liquid crystal cell; a first polarizing plate disposed on a surface of the liquid crystal cell and including a first polarizer; and a second polarizing plate disposed on the other surface of the liquid crystal cell and including a second polarizer, in which the liquid crystal cell includes an array substrate including a thin film transistor, a counter substrate, and a liquid crystal layer disposed between the array substrate and the counter substrate and including liquid crystal molecules; the liquid crystal cell is such that the liquid crystal molecules are oriented perpendicularly to a surface of the array substrate when no voltage is applied and the liquid crystal molecules are oriented horizontally to the surface of the array substrate when a voltage is applied; and the first polarizing plate has a retardation film according to [1] provided on a surface of the first polarizer facing the liquid crystal cell, or the second polarizing plate has the retardation film according to [1] provided on a surface of the second polarizer facing the liquid crystal cell.

[9] A liquid crystal display device including: a liquid crystal cell; a first polarizing plate disposed on a surface of the liquid crystal cell and including a first polarizer; and a second polarizing plate disposed on the other surface of the liquid crystal cell and including a second polarizer, in which the liquid crystal cell includes an array substrate including a thin film transistor, a counter substrate, and a liquid crystal layer disposed between the array substrate and the counter substrate and including liquid crystal molecules; the liquid crystal cell is such that the liquid crystal molecules are oriented perpendicularly to a surface of the array substrate when no voltage is applied and the liquid crystal molecules are oriented horizontally to the surface of the array substrate when a voltage is applied; and the first polarizing plate is obtained by a method according to [7], and a retardation film of the first polarizing plate is disposed on a surface of the first polarizer facing the liquid crystal cell, or the second polarizing plate is obtained by a method according to [7], and a retardation film of the second polarizing plate is disposed on a surface of the second polarizer facing the liquid crystal cell.

[10] The liquid crystal display device according to [8] or [9], in which the array substrate of the liquid crystal cell further includes a color filter.

### Advantageous Effects of Invention

The retardation film of the present invention swells only a little when immersed in a saponifying solution and has good adhesiveness to polarizer, even though the film includes cellulose acetate having a degree of substitution of acyl groups. A color shift can thereby be suppressed with the liquid crystal display device including the retardation film.

### BRIEF DESCRIPTION OF DRAWINGS

FIG. 1 is a schematic view showing an example of a liquid crystal display device of the present invention;

FIG. 2 is a sectional view of a liquid crystal cell laminate having a COA structure;

FIG. 3 is a top view of an array substrate of the liquid crystal cell having a COA structure shown in FIG. 2;

FIG. 4 is a schematic view showing another example of the liquid crystal display device of the present invention; and

FIG. 5 is a schematic view showing an example of a sample for measuring adhesiveness.

### DESCRIPTION OF EMBODIMENTS

1. Retardation film

A retardation film of the present invention contains at least a cellulose ester and a glass-transition-temperature lowering agent.

Cellulose Ester

The cellulose ester is a compound obtained by esterifying a hydroxyl group of cellulose with an aliphatic carboxylic acid or an aromatic carboxylic acid.

An acyl group included in the cellulose ester is an aliphatic acyl group or an aromatic acyl group, and preferably an aliphatic acyl group. Among them, a C₂₋₆ aliphatic acyl group is preferable in order to obtain a retardation developing property of a certain level or more, and a C₂₋₄ aliphatic acyl group is more preferable. Examples of the C₂₋₄ aliphatic acyl group include an acetyl group, a propionyl group, and a butanoyl group. More preferred is an acetyl group.

Examples of the cellulose ester include cellulose acetate, cellulose propionate, cellulose butyrate, cellulose acetate propionate, and cellulose acetate butyrate. Preferred example includes cellulose acetate. The cellulose acetate preferably has acyl groups all of which included in the cellulose ester are acetyl groups.

The total degree of substitution of acyl groups of the cellulose ester, preferably the degree of substitution of acetyl groups of cellulose acetate, is preferably 2.0 to 2.55, more preferably 2.2 to 2.5, and still more preferably 2.3 to 2.45, since retardation is likely to be developed by stretching.

The degree of substitution of acyl groups of the cellulose ester can be measured according to ASTM-D817-96.

In order to suppress the axis deviation of the retardation film subjected to saponification treatment and the polarizer in the present invention, it is effective to decrease the swelling (dimensional change) of the retardation film when the film is immersed in a saponifying solution. In order to decrease the swelling of the retardation film when the film is immersed in the saponifying solution, the cellulose ester included in the retardation film preferably has a branching degree of a certain level or more. The cellulose ester having a branching degree of a certain level or more is considered to be less likely to absorb water, since the cellulose ester has a matrix structure having a crosslinking point, for example.

The branching degree of a cellulose ester is represented by a slope of a plot, the plot being obtained plotting a common logarithm log [Mw(a)] of an absolute molecular weight Mw(a) on an abscissa axis versus a common logarithm log [Iv(a)] of an intrinsic viscosity Iv(a) on an ordinate axis, through GPC (Gel permeation chromatography)-LALLS (Low Angle LASER. Light Scattering: low angle laser light scattering)-viscosity measurement. The slope of the plot is preferably 0.65 to 0.85, and more preferably 0.70 to 0.80. When the slope of the plot is less than 0.65, the branching degree of the cellulose ester is low, and thereby the cellulose ester does not sufficiently form a matrix structure having crosslinking points (or is not self-organized) and is prone to absorb water. On the other hand, when the slope of the plot is more than 0.85, the branching degree of the cellulose ester is so high that the flexibility of the film to be obtained decreases or the affinity of the film to be obtained with the saponifying solution decreases, which is less likely to provide sufficient adhesiveness to the polarizer.

The following procedures can be carried out to measure the branching degree of a cellulose ester.

(1) 0.1 g of synthesized cellulose acetate and 10 ml of THF are placed in a 20 ml test tube, and dissolved at 25° C. for 4 hours. The obtained solution is filtered through a simple treatment filter to prepare a solution sample for GPC-LALLS-viscosity measurement.

(2) The solution sample obtained in the procedure (1) is subjected to GPC-LALLS-viscosity measurement under the following conditions.

(Measurement Conditions)

Apparatus: HLC-8220GPC manufactured by Tosoh Corporation

Columns: TSK gel (R) Super AWM-Hx2 (manufactured by Tosoh Corporation), packing material: hydrophilic polymethacrylate

Detector: Model302 manufactured by Viscotek (a triple detector including a refractive-index meter, a scattering intensity meter, and a viscometer (4 capillary (bridge type) differential pressure viscometer) as detectors)

Solution sending temperature: 40° C.

Solvent: THF

Flow rate: 0.4 ml/min

Injection volume: 500 μl

A plot of a common logarithm log [Mw] of an absolute molecular weight Mw on the abscissa axis versus a common logarithm log [Iv(a)] of a viscosity Iv(a) on the ordinate axis is obtained through GPC-LALLS-viscosity measurement. The plot is obtained by Mark-Houwink plot using an analysis software included a main unit for the arbitrary specified analysis range. The slope a(log [Iv(a)]/log [Mw]) of the obtained plot is determined

The branching degree of the cellulose ester can be adjusted according to the synthesis method and condition of the cellulose ester. For example, a cellulose ester having a branching degree of a certain level or more can be obtained through (1) activating cellulose as a raw material using acetic acid or the like (activation step); (2) adding a second sugar (mannan, xylan, or the like) to the activated cellulose to crosslink the cellulose (crosslinking step); (3) reacting the cellulose subjected to the step (2) with acetic anhydride in the presence of a sulfuric acid catalyst to obtain cellulose triacetate (acetylation step); and (3) subjecting the obtained cellulose triacetate to saponification (hydrolysis)-aging to adjust a degree of acetylation (saponification-aging step).

In other words, when the second sugar is added to the non-activated cellulose, the cellulose and the second sugar are considered to be less likely to be crosslinked; however, when the second sugar is added to the activated cellulose, the activated cellulose and the second sugar are considered to be likely to be crosslinked.

The activation step (1) can be carried out by spraying a mist of acetic acid or aqueous acetic acid on raw material cellulose or by immersing the raw material cellulose in acetic acid or aqueous acetic acid. The addition amount of acetic acid may be preferably 10 parts by mass to 600 parts by mass, preferably 20 parts by mass to 80 parts by mass, and still more preferably 30 parts by mass to 60 parts by mass based on 100 parts by mass of the raw material cellulose.

Examples of the raw material cellulose include cotton linter, wood pulp (obtained from acicular trees or from broad leaf trees), and kenaf. The wood pulp is preferable, since a cellulose ester having a high branching degree is easily synthesized. The raw material celluloses may be used each alone or in combination of two or more kinds.

The second sugar is added to the activated cellulose to crosslink the cellulose in the crosslinking step (2). Examples of the second sugar to be added include mannan, xylan, mannose, xylose, and glucomannan.

The addition amount of the second sugar may be 1 part by mass to 10 parts by mass, and preferably 1 part by mass to 7 parts by mass based on 100 parts by mass of the raw material cellulose. When the addition amount of the second sugar is less than 1 part by mass, the cellulose cannot be sufficiently crosslinked, which is prone to cause a decrease in the branching degree of the cellulose ester to be obtained. When the addition amount of the second sugar is more than 10 parts by mass, on the other hand, the branching degree of the cellulose ester to be obtained is too high, which is prone to cause a decrease in the affinity with the saponifying solution.

In the acetylation step (3), acetic anhydride is added to the cellulose obtained in the step (2), for example, cellulose having a matrix structure having a crosslinking point, in the presence of a sulfuric acid catalyst to acetylate the cellulose. In the acetylation step, monomers (e.g., xylose and mannose which are constituents of xylan and mannan, respectively) of the second sugar may be further added, if needed.

The addition amount of acetic anhydride can be selected and set according to the degree of acetylation of the cellulose ester to be obtained. The addition amount of acetic anhydride may be, for example, 230 parts by mass to 300 parts by mass, preferably 240 parts by mass to 290 parts by mass, and more preferably 250 parts by mass to 280 parts by mass based on 100 parts by mass of the raw material cellulose.

The amount of the sulfuric acid catalyst to be used is usually 1 part by weight to 15 parts by weight, preferably 5 parts by weight to 15 parts by weight, and particularly about 5 parts by weight to about 10 parts by weight based on 100 parts by weight of the cellulose.

In the acetylation step, a solvent such as acetic acid may be further used. The amount of the acetic acid to be used may be, for example, 200 parts by mass to 700 parts by mass, preferably 300 parts by mass to 600 parts by mass, and more preferably 350 parts by mass to 500 parts by mass based on 100 parts by mass of the raw material cellulose.

An acetylation temperature is preferably 45° C. to 70° C., and more preferably 50° C. to 60° C. in order to easily crosslink the cellulose.

In the saponification-aging step (4), a calcium acetate aqueous solution is added to the cellulose triacetate obtained in the step (3). Water at about 100° C. is further added to the obtained reaction product, and a moisture amount (aging moisture amount) in the reaction product is adjusted to about 50 mol % to about 80 mol %. The saponification-aging step is preferably carried out at 40° C. to 90° C.

In order to adjust the optical characteristics of the cellulose acetate, the produced cellulose ester may be further treated with an oxidizing agent, for example, after the acetylation step (3) or the saponification-aging step (4).

Examples of the oxidizing agent to be used include hydrogen peroxide; peracids such as performic acid, peracetic acid, and perbenzoic acid; and organic peroxides such as diacetyl peroxide. Among them, preferred are hydrogen peroxide, performic acid, peracetic acid, and the like, since these are easily separated from the cellulose ester and are less likely to remain. Particularly preferred are hydrogen peroxide and peracetic acid. These oxidizing agents may be used each alone or in combination of two or more kinds. The amount of the oxidizing agent to be used may be, for example, 0.01 part by mass to 5 parts by mass, preferably 0.1 parts by mass to 2.5 parts by mass, and particularly about 0.1 parts by mass to about 1 part by mass based on 100 parts by mass of the cellulose ester.

The range of the absolute molecular weight Mw(s) of the cellulose ester obtained through the GPC-LALLS-viscosity measurement method is preferably 0.8×10⁵ to 2.6×10⁵, and more preferably 1.0×10⁵ to 1.5×10⁵.

In order to obtain a film having mechanical strength of a certain level or more, the number average molecular weight of the cellulose ester is preferably 3.0×10⁴ or more and 9.0×10⁴ or less, and more preferably 4.5×10⁴ or more and 8.5×10⁴ or less. The weight average molecular weight of the cellulose ester is preferably 1.1×10⁵ or more and less than 3.0×10⁵, more preferably 1.2×10⁵ or more and 2.5×10⁵ or less, and still more preferably 1.5×10⁵ or more and less than 2.0×10⁵.

The distribution of molecular weight of the cellulose ester ((weight average molecular weight)/(number average molecular weight)) is preferably 1.8 to 4.5.

The number average molecular weight and the weight average molecular weight of the cellulose ester can be measured under the same conditions as described above by the GPC-LALLS-viscosity measurement method.

Glass-Transition-Temperature Lowering Agent

Examples of the glass-transition-temperature lowering agent include polyester compounds, polyhydric alcohol ester compounds, polyvalent carboxylic acid ester compounds (including phthalic acid ester compounds), glycolate compounds, and ester compounds (including fatty acid ester compounds, phosphoric acid ester compounds, and the like). These compounds may be used singly or in combination.

The polyester compound is preferably a polyester compound represented by General Formula (I).

[Chemical Formula 1]

X—O—B—[O—C(═O)-A-C(═O)—O—B]n-O—X General Formula (I)

A in General Formula (I) represents a C₆₋₁₄ arylene group, a linear or branched C₂₋₆ alkylene group, or a C₃₋₁₀ cycloalkylene group. Preferred is a C₆₋₁₄ allylene group, and more preferred is phenylene group, naphthylene group, or biphenylylene group because of their excellent Tg lowering capability. B represents a linear or branched C₂₋₆ alkylene group or a C₃₋₁₀ cycloalkylene group. X represents a hydrogen atom, or a residue of a C₆₋₁₄ aromatic monocarboxylic acid or a C₁₋₆ aliphatic monocarboxylic acid. Preferred is a hydrogen atom or a residue of a C₆₋₁₄ aromatic monocarboxylic acid. n represents a natural number of 1 or more.

The polyester compound represented by General Formula (I) can be obtained by subjecting a dicarboxylic acid having a C₆₋₁₄ arylene group, a linear or branched C₂₋₆ alkylene group, or a C₃₋₁₀ cycloalkylene group and a diol having a linear or branched C₂₋₆ alkylene group or a C₃₋₁₀ cycloalkylene group to a condensation reaction, and thereafter blocking a terminal with an aromatic monocarboxylic acid or an aliphatic monocarboxylic acid, if needed.

Examples of the dicarboxylic acid having a C₆₋₁₄ arylene group include phthalic acid, isophthalic acid, terephthalic acid, 1,5-naphthalene dicarboxylic acid, 1,4-naphthalene dicarboxylic acid, 1,8-naphthalene dicarboxylic acid, 2,3-naphthalene dicarboxylic acid, 2,6-naphthalene dicarboxylic acid, 2,8-naphthalene dicarboxylic acid, 2,2′-biphenyl dicarboxylic acid, and 4,4′-biphenyl dicarboxylic acid. Preferred are terephthalic acid, 2,6-naphthalene dicarboxylic acid, and 4,4′-biphenyl dicarboxylic acid. The arylene group included in the dicarboxylic acids may further have substituents such as a C₁₋₆ alkyl group, a C₂₋₆ alkenyl group, or a C₁₋₆ alkoxy group.

Examples of the dicarboxylic acid having a linear or branched C₂₋₆ alkylene group include malonic acid, succinic acid, glutaric acid, adipic acid, pimelic acid, and suberic acid. Preferred are succinic acid and adipic acid. Examples of the dicarboxylic acid having a C₃₋₁₀ cycloalkylene group include 1,2-cyclohexanedicarboxylic acid and 1,4-cyclohexanedicarboxylic acid. Preferred is 1,4-cyclohexanedicarboxylic acid.

Examples of the diol having a linear or branched C₂₋₆ alkylene group include ethanediol (ethylene glycol), 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, and 1,6-hexanediol. Preferred are ethanediol (ethylene glycol), 1,2-propanediol, 1,3-propanediol, and 1,3-butanediol.

Examples of the diol having a linear or branched C₃₋₁₀ cycloalkylene group include 1,4-cyclohexanediol and 1,4-cyclohexanedimethanol.

Examples of the residue of a C₆₋₁₄ aromatic monocarboxylic acid include residues of benzoic acid, o-toluic acid, m-toluic acid, p-toluic acid, p-tert-butylbenzoic acid, dimethylbenzoic acid, and p-methoxybenzoic acid. Preferred are residues of benzoic acid, p-toluic acid, and p-tert-butylbenzoic acid. Examples of the residue of a C₁₋₆ aliphatic monocarboxylic acid include residues of acetic acid, propionic acid, and butanoic acid.

Specific examples of the polyester compound represented by General Formula (I) will be shown below. In the following specific examples, all of Xs in General Formula (I) may be hydrogen atoms.

[Chemical Formula 2]

| | Aromatic Dicarboxylic Acid Skelton (A) | Diol Skelton (B) |
|---|---|---|
| PES-1 | 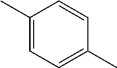 | 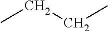 |
| PES-2 | 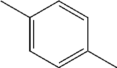 | 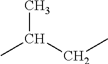 |
| PES-3 | 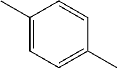 | 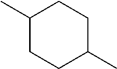 |
| PES-4 | 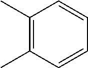 | 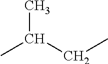 |
| PES-5 | 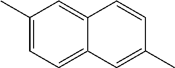 | 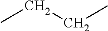 |
| PES-6 | 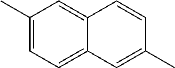 | 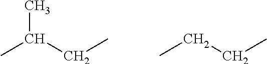 |
| PES-7 | 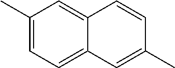 | 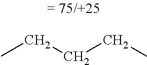 |

[Chemical Formula 3]

| | Aromatic Dicarboxylic Acid Skelton (A) | Diol Skelton (B) |
|---|---|---|
| PES-8 | 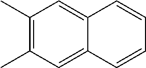 | 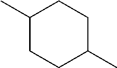 |
| PES-9 | 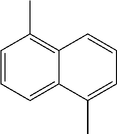 | 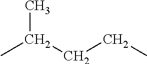 |
| PES-10 | 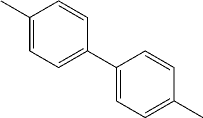 | 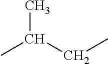 |
| PES-11 | 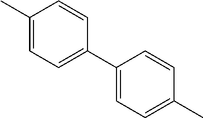 | 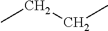 |
| PES-12 | 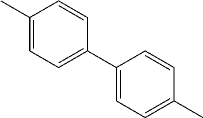 | 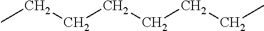 |
| PES-13 | 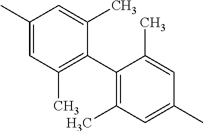 | 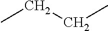 |
| PES-14 | 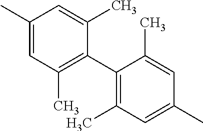 | 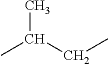 |

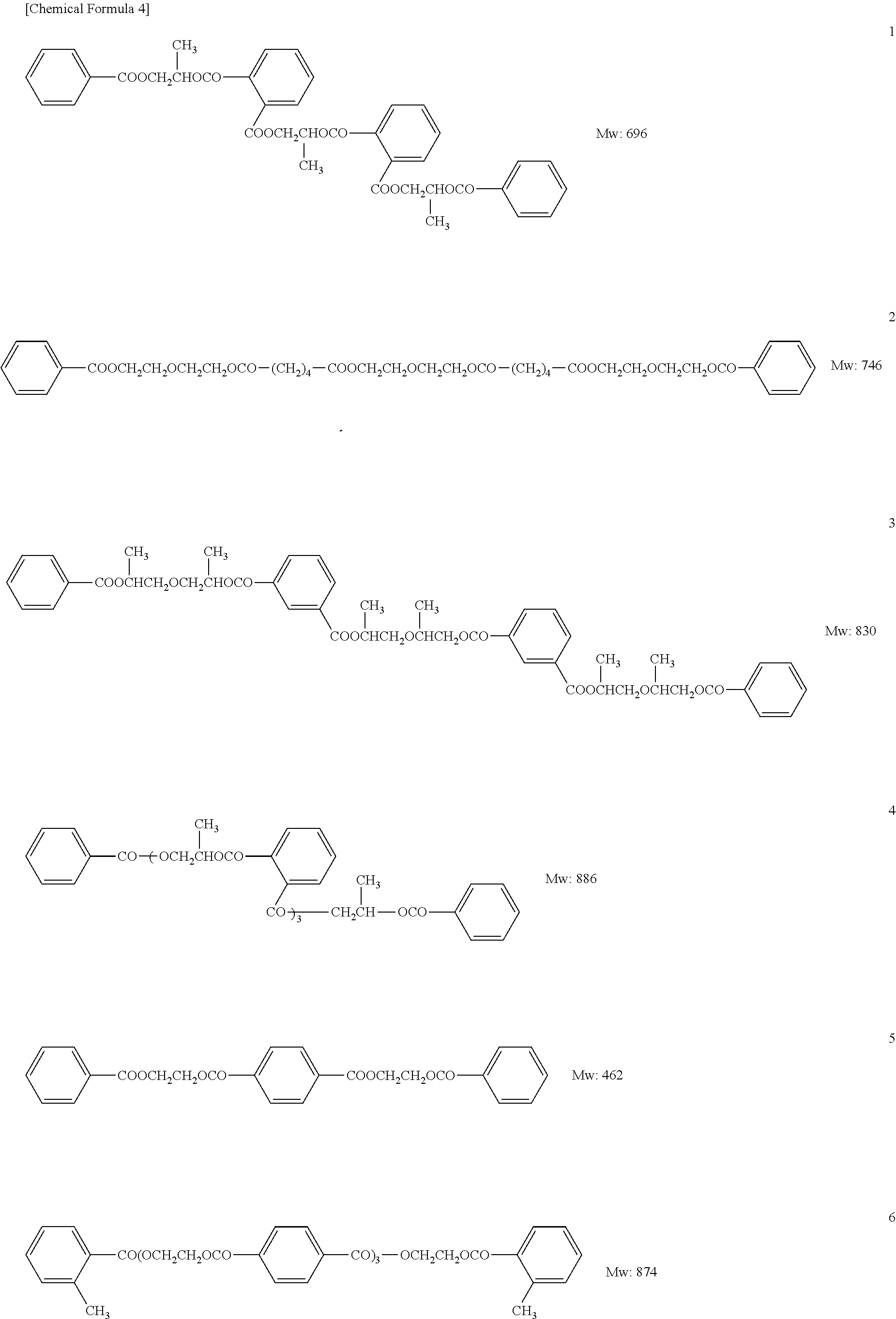

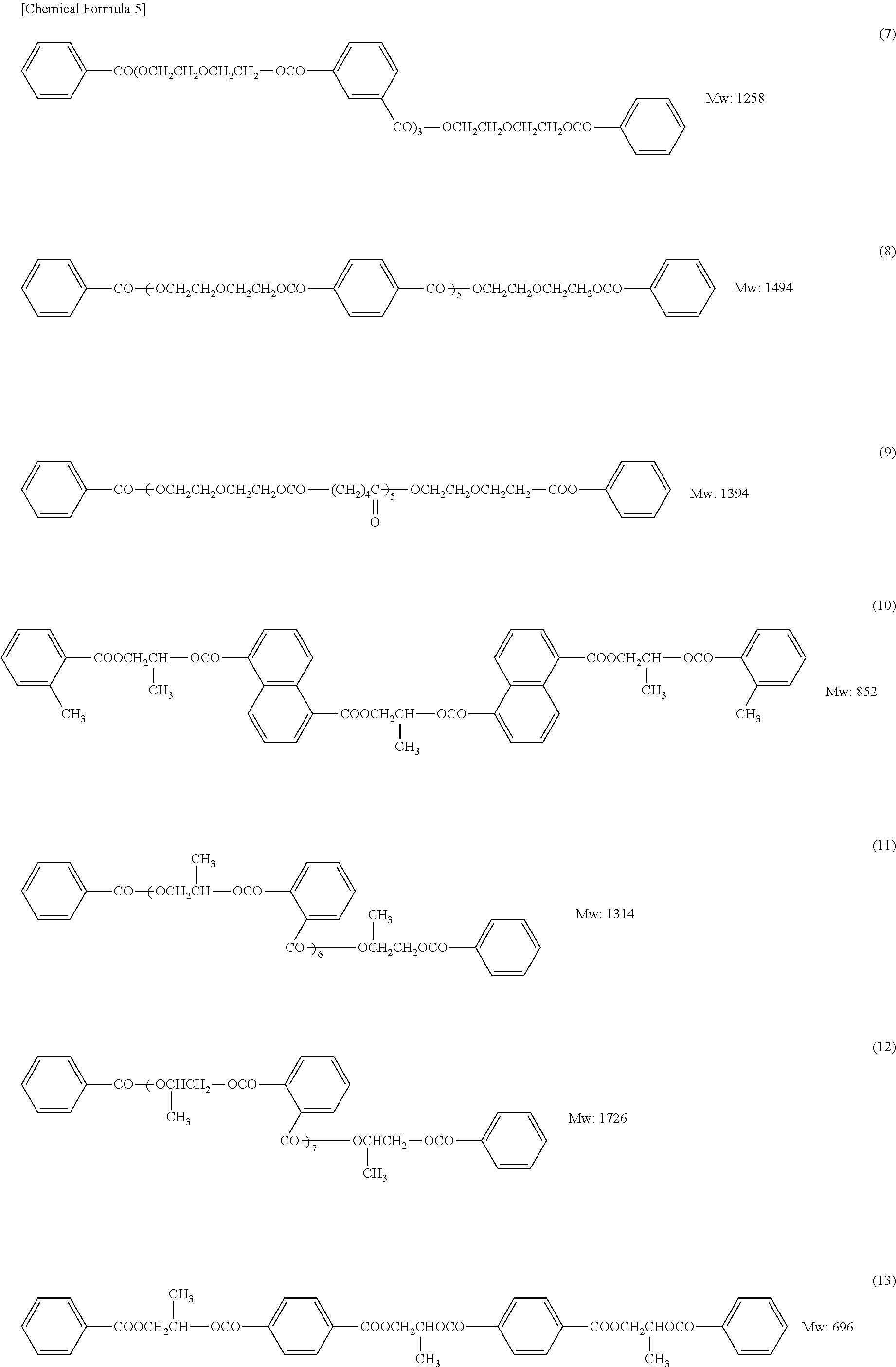

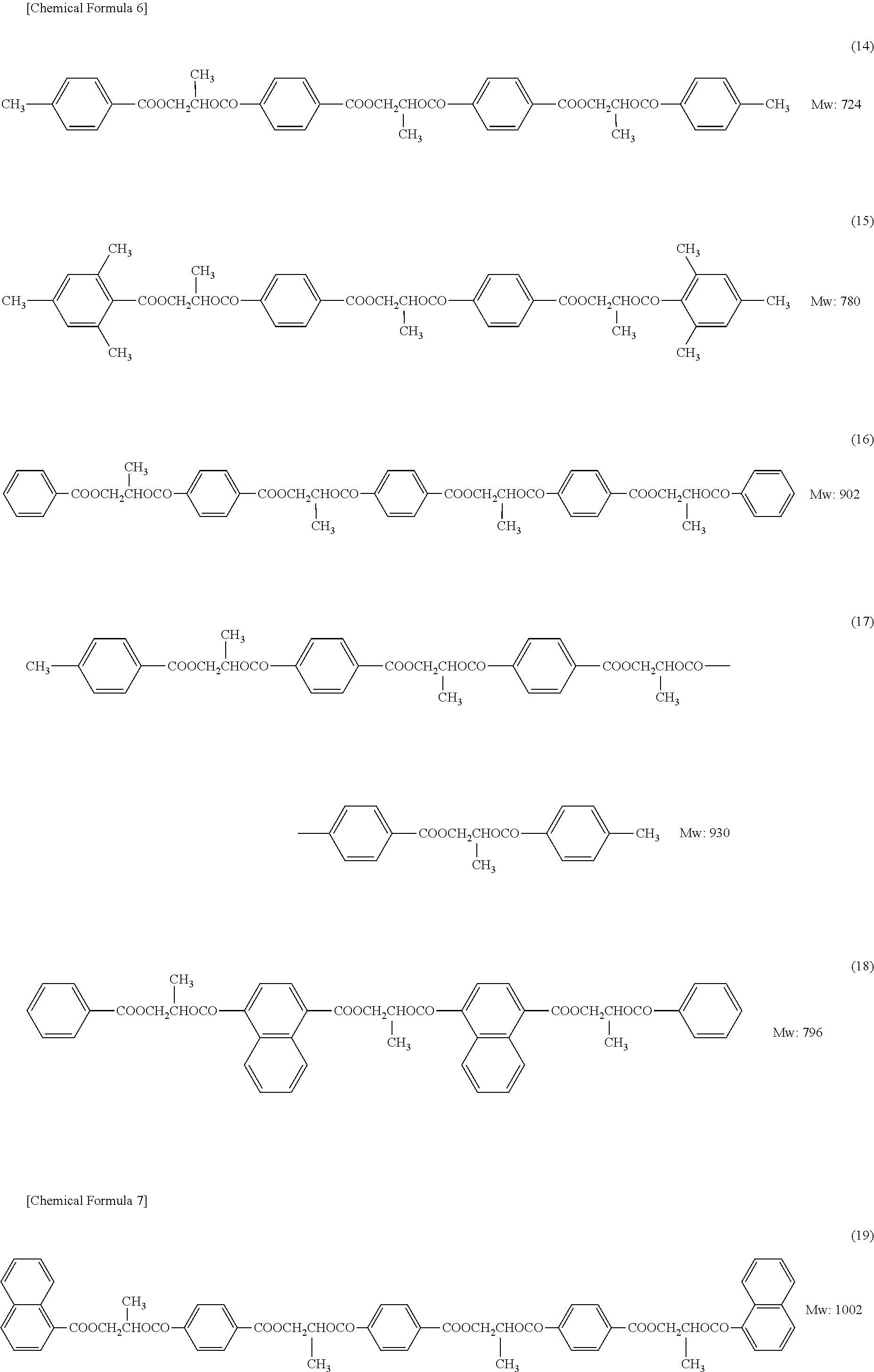

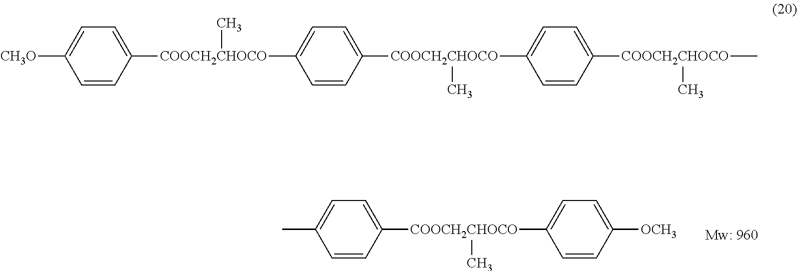

A polyhydric alcohol ester compound is an ester compound between a divalent or higher-valent aliphatic polyhydric alcohol and a monocarboxylic acid (alcohol ester), and is preferably a divalent to eicosavalent aliphatic polyhydric alcohol ester. It is preferable that the polyhydric alcohol ester compound have an aromatic ring or a cycloalkyl ring in the molecule.

Preferable examples of the aliphatic polyhydric alcohol include ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, trimethylol propane, pentaerythritol, trimethylolethane, and xylitol. Among them, preferred are triethylene glycol, tetraethylene glycol, dipropylene glycol, tripropylene glycol, sorbitol, trimethylol propane, and xylitol.

The monocarboxylic acid is not particularly limited, and may be an aliphatic monocarboxylic acid, an alicyclic monocarboxylic acid, or an aromatic monocarboxylic acid. Preferred is the alicyclic monocarboxylic acid or the aromatic monocarboxylic acid in order to improve the moisture permeability of the film and be less likely to volatilize the monocarboxylic acid. The monocarboxylic acids may be used singly or as a mixture thereof. Furthermore, all of the OH groups contained in the aliphatic polyhydric alcohol may be esterified, or some of them may be left as OH groups.

The aliphatic monocarboxylic acid is preferably a linear or branched fatty acid having 1 to 32 carbon atoms. The number of carbon atoms of the aliphatic monocarboxylic acid is more preferably 1 to 20, and even more preferably 1 to 10. Examples of the aliphatic monocarboxylic acid include saturated fatty acids such as acetic acid, propionic acid, butyric acid, valeric acid, caproic acid, enanthic aid, caprylic acid, pelargonic acid, capric acid, 2-ethyl-hexanoic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid; and unsaturated fatty acids such as undecylenic acid, oleic acid, sorbic acid, linoleic acid, linolenic acid, and arachidonic acid. Among them, preferred is acetic acid or a mixture of acetic acid and other monocarboxylic acid in order to improve compatibility with cellulose acetate.

Examples of the alicyclic monocarboxylic acid include cyclopentanecarboxylic acid, cyclohexanecarboxylic acid, and cyclooctanecarboxylic acid.

Examples of the aromatic monocarboxylic acid include benzoic acid; benzoic acid having one to three alkyl groups or alkoxy groups (for example, methoxy groups or ethoxy groups) introduced to the benzene ring (for example, toluic acid); and an aromatic monocarboxylic acid having two or more benzene rings (for example, biphenylcarboxylic acid, naphthalenecarboxylic acid, or tetralinecarboxylic acid). A preferred example of the aromatic monocarboxylic acid is benzoic acid.

Specific examples of the polyhydric alcohol ester compound will be shown below. Specific examples of the divalent alcohol ester compounds include the following.

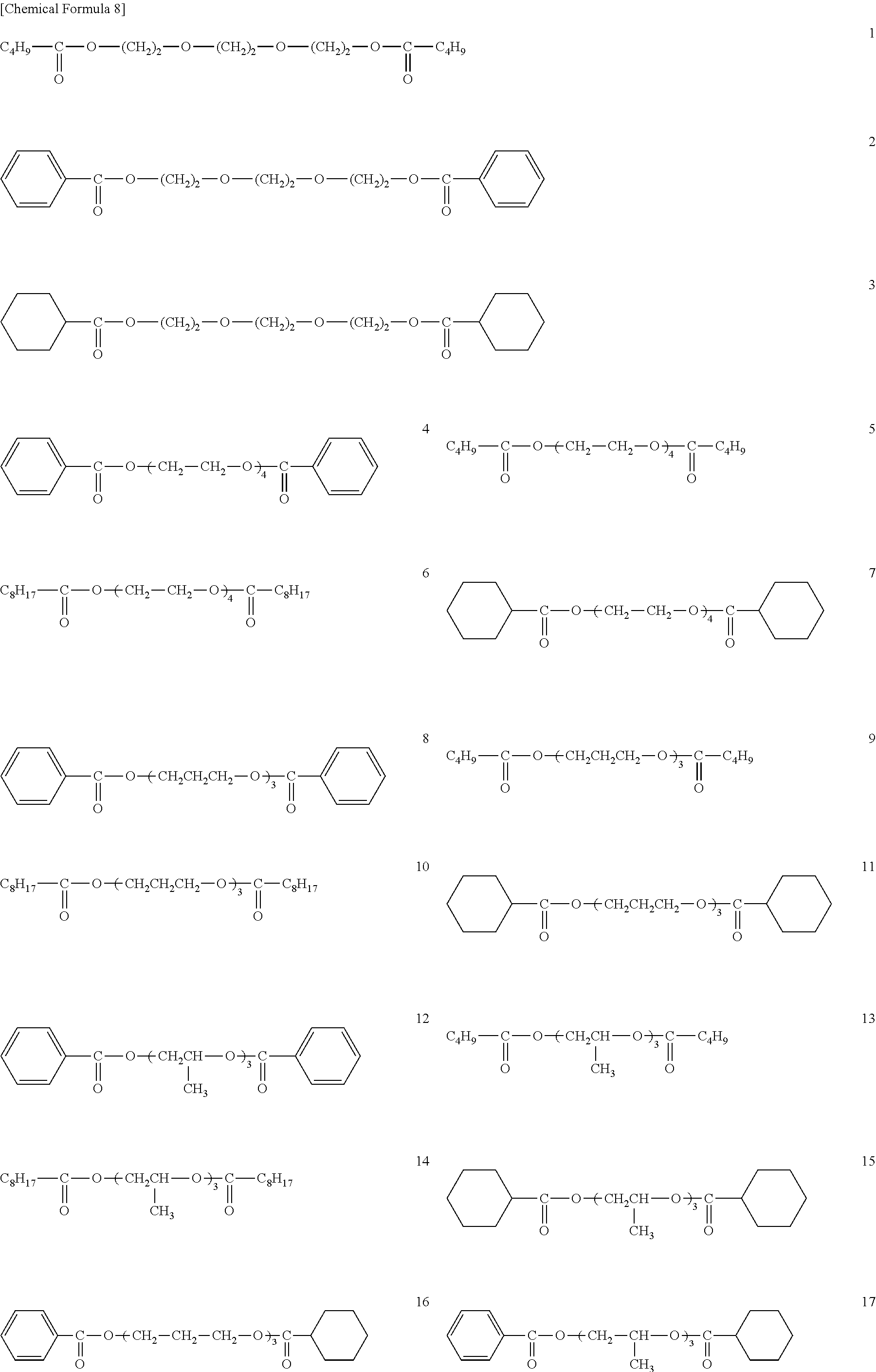

Examples of the trivalent or higher alcohol ester compound include the following compounds.

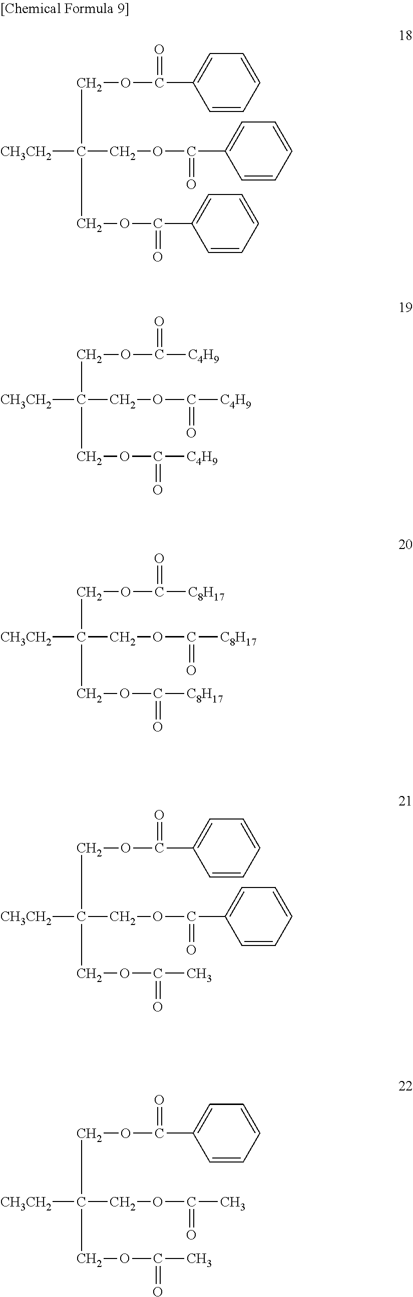

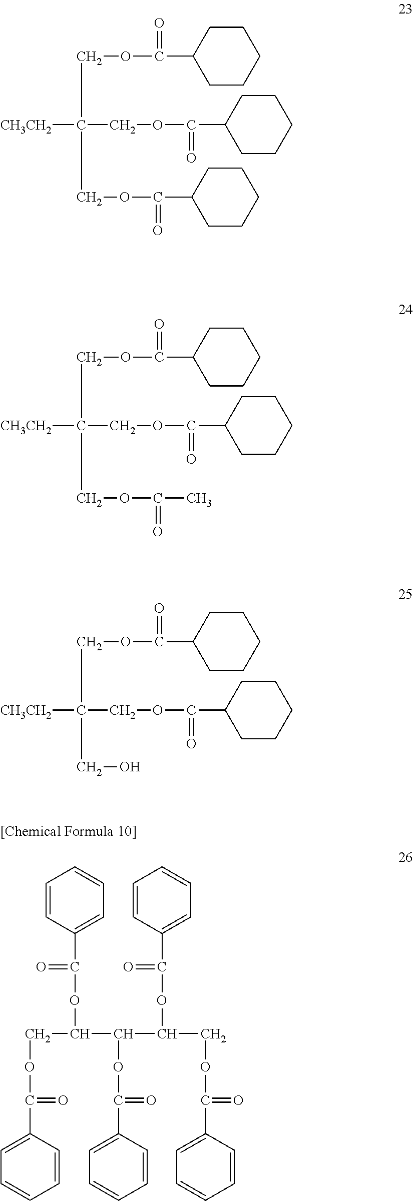

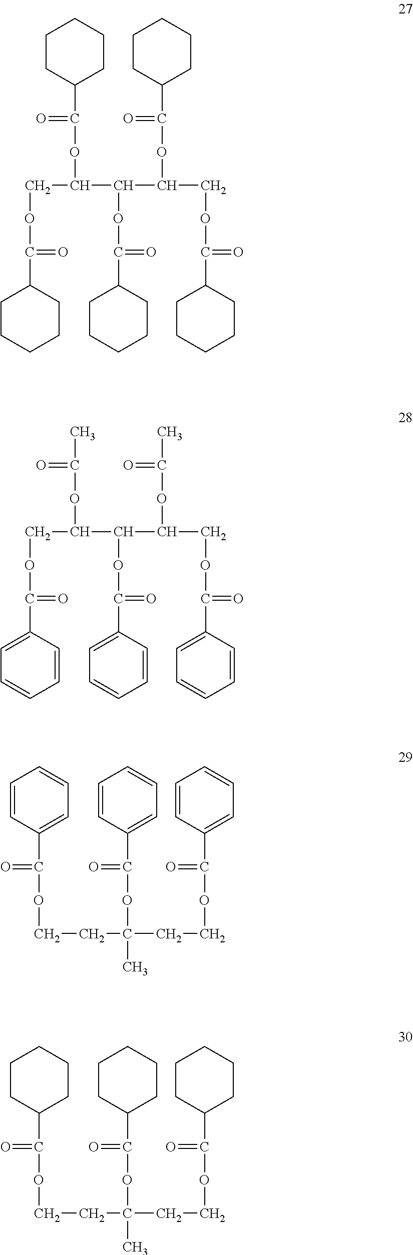 [SMILES: O=C(OCC(OC(=O)C1CCCCC1)C(OC(=O)C1CCCCC1)C(COC(=O)C1CCCCC1)OC(=O)C1CCCCC1)C1CCCCC1 ; CC(=O)OC(COC(=O)c1ccccc1)C(OC(=O)c1ccccc1)C(COC(=O)c1ccccc1)OC(C)=O ; CC(CCOC(=O)c1ccccc1)(CCOC(=O)c1ccccc1)OC(=O)c1ccccc1 ; CC(CCOC(=O)C1CCCCC1)(CCOC(=O)C1CCCCC1)OC(=O)C1CCCCC1]

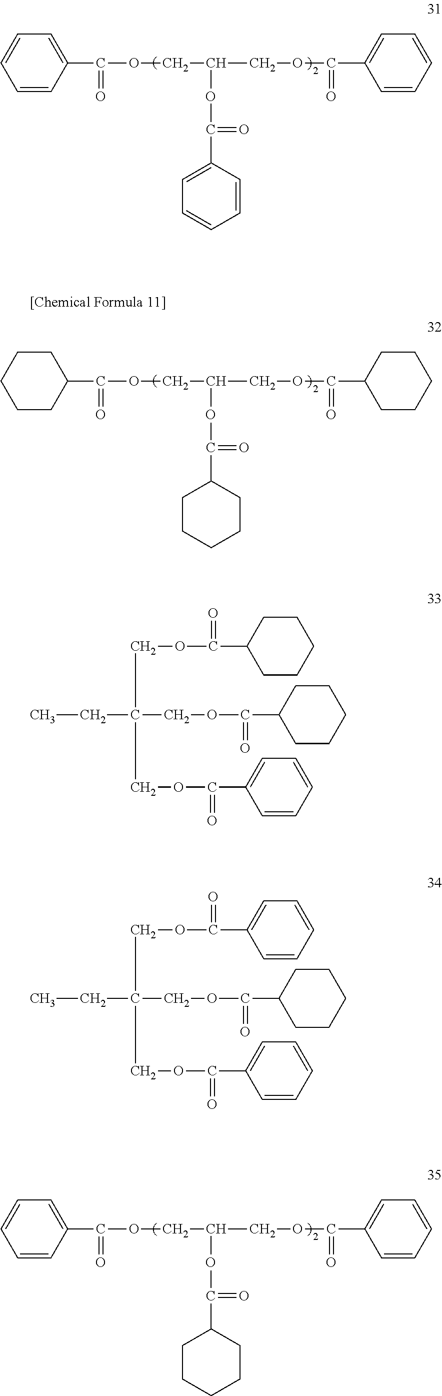 [SMILES: O=C(OCC(COC(=O)c1ccccc1)OC(=O)c1ccccc1)c1ccccc1 ; O=C(OCC(COC(=O)C1CCCCC1)OC(=O)C1CCCCC1)C1CCCCC1 ; CCC(COC(=O)c1ccccc1)(COC(=O)C1CCCCC1)COC(=O)C1CCCCC1 ; CCC(COC(=O)c1ccccc1)(COC(=O)c1ccccc1)COC(=O)C1CCCCC1 ; O=C(OCC(COC(=O)c1ccccc1)OC(=O)C1CCCCC1)c1ccccc1]

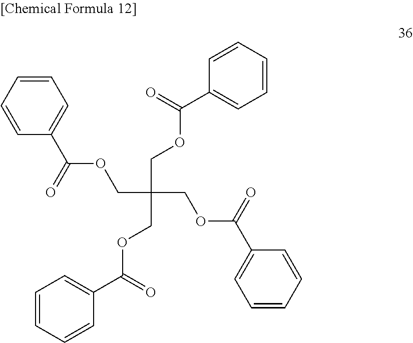 [SMILES: O=C(OCC(COC(=O)c1ccccc1)(COC(=O)c1ccccc1)COC(=O)c1ccccc1)c1ccccc1]

A polyvalent carboxylic acid ester compound is an ester compound between a divalent or higher-valent, preferably divalent to eicosavalent, polyvalent carboxylic acid and an alcohol compound. The polyvalent carboxylic acid is preferably a divalent to eicosavalent aliphatic polyvalent carboxylic acid, a trivalent to eicosavalent aromatic polyvalent carboxylic acid, or trivalent to eicosavalent alicyclic polycarboxylic acid.

Examples of the polyvalent carboxylic acid include trivalent or higher-valent aromatic polyvalent carboxylic acids such as trimellitic acid, trimesic acid and pyromellitic acid, or derivatives thereof; aliphatic polyvalent carboxylic acids such as succinic acid, adipic acid, azelaic acid, sebacic acid, oxalic acid, fumaric acid, maleic acid, and tetrahydrophthalic acid; and polyvalent oxycarboxylic acids such as tartaric acid, tartronic acid, malic acid, and citric acid. In order to suppress volatilization from the film, a polyvalent oxycarboxylic acid is preferred.

Examples of the alcohol compound include a linear or branched saturated aliphatic alcohol compound, a linear or branched unsaturated aliphatic alcohol compound, an alicyclic alcohol compound, or an aromatic alcohol compound. The number of carbon atoms of the saturated aliphatic alcohol compound or unsaturated aliphatic alcohol compound is preferably 1 to 32, more preferably 1 to 20, and even more preferably 1 to 10. Examples of the alicyclic alcohol compound include cyclopentanol and cyclohexanol. Examples of the aromatic alcohol compound include benzyl alcohol, and cinnamyl alcohol.

The molecular weight of the polyvalent carboxylic acid ester compound is not particularly limited and is preferably 300 to 1,000, and more preferably 350 to 750. The molecular weight of the polyvalent carboxylic acid ester-based plasticizer is preferably larger from the viewpoint of suppressing bleed-out; and from the viewpoint of moisture permeability or compatibility with cellulose acetate, the molecular weight is preferably smaller.

Examples of the polyvalent carboxylic acid ester compound include triethyl citrate, tributyl citrate, acetyltriethyl citrate (ATEC), acetyltributyl citrate (ATBC), benzoyltributyl citrate, acetyltriphenyl citrate, acetyltribenzyl citrate, dibutyl tartrate, and diacetyldibutyl tartarate, tributyl trimellitate, and tetrabutyl pyromellitate.

The polyvalent carboxylic acid ester compound may be a phthalic acid ester compound. Examples of the phthalic acid ester compound include diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, and dicyclohexyl terephthalate.

Examples of the glycolate compound include alkyl phthalyl alkyl glycolate. Examples of the alkyl phthalyl alkyl glycolate include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate.

Examples of the ester compound include fatty acid ester compounds, citric acid ester compounds, and phosphoric acid ester compounds.

Examples of the fatty acid ester compounds include butyl oleate, methyl acetyl ricinolate, and dibutyl sebacate. Examples of the citric acid ester compounds include acetyl trimethyl citrate, acetyl triethyl citrate, and acetyl tributyl citrate. Examples of the phosphoric acid ester compounds include triphenyl phosphate, tricresyl phosphate, cresyl diphenyl phosphate, octyl diphenyl phosphate, biphenyl diphenyl phosphate, trioctyl phosphate, and tributyl phosphate.

Among them, preferred are the polyester compound and the phosphoric acid ester compound.

The Tg lowering capability of the glass-transition-temperature lowering agent is preferably 3.5° C./part by mass or higher, more preferably 3.8° C./part by mass or higher, and still more preferably 4.0° C./part by mass or higher. When the Tg lowering capability of the glass-transition-temperature lowering agent is within the above range, an excellent Tg lowering effect is obtained even with a small addition amount. Meanwhile, the Tg lowering capability of the glass-transition-temperature lowering agent is usually 10.0° C./part by mass or below.

The Tg lowering capability of the glass-transition-temperature lowering agent is defined by the following Formula. In the following Formula, X represents Tg of a film made of cellulose acetate; and Y represents Tg of a film made of 100 parts by mass of cellulose acetate and 5 parts by mass of a glass-transition-temperature lowering agent. The Tg of the film can be measured by differential scanning calorimetry (DSC).

$$Tg lowering capability = \frac{X - Y}{5} [ ° C . \text{/} part by mass ] \qquad Formula ( 6 )$$

The SP value of the glass-transition-temperature lowering agent is preferably within the range of 9.0 to 11.0. Since a glass-transition-temperature lowering agent having an SP value of less than 9.0 has low compatibility with the cellulose ester, the film including the glass-transition-temperature lowering agent is prone to have high haze. Since a glass-transition-temperature lowering agent having an SP value of more than 11.0 has high compatibility with water, on the other hand, the film including the glass-transition-temperature lowering agent is prone to swell when immersed in the saponifying solution.

The SP value can be calculated using the parameters of Hoy, Fedors, Small, or the like. The SP value according to the present invention is preferably calculated using parameters of Fedors, which are of variety of types and are applicable to a wide range of compounds. A unit of (cm³/cal)¹″² which is a square root of a value obtained by dividing cohesion energy density AE by molar volume V can be used as the unit of the SP value. The parameters of Fedors are described in a reference document, pages 54-57 of “Basic Science for Coating” by Yuji Harada, published by Maki Shoten (1977).

The content of the glass-transition-temperature lowering agent is preferably 1 mass % to 15 mass %, and more preferably 1.5 mass % to 10 mass % based on the cellulose ester. When the content of the glass-transition-temperature lowering agent is less than 1 mass %, a Tg lowering effect may be insufficiently caused by the glass-transition-temperature lowering agent. When the content of the glass-transition-temperature lowering agent is more than 10 mass %, on the other hand, the retardation of the retardation film may be less likely to be sufficiently obtained.

Fine Particle (Mat Agent)

The retardation film may further contain fine particles (mat agent) in order to improve a surface sliding property.

The fine particles may be inorganic fine particles or organic fine particles.

Examples of the inorganic fine particle include silicon dioxide (silica), titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. Among them, preferred are silicon dioxide and zirconium oxide, and more preferred is silicon dioxide in order to lessen an increase in the haze of the film to be obtained.

Examples of fine particles of silicon dioxide include AEROSIL R972, R972V, R974, R812, 200, 200V, 300, 8202, OX50, TT600, NAX50 (all manufactured by Nippon Aerosil Co., Ltd.), and SEAHOSTAR KE-P10, KE-P30, KE-P50, KE-P100 (all manufactured by Nippon Shokubai Co., Ltd.). Among them, particularly preferred are Aerosil R972V, NAX50, SEAHOSTAR KE-P30, and the like, since these can decrease a coefficient of friction while keeping a low turbidity of the film to be obtained.

The fine particles have a primary particle size of, preferably 5 nm to 50 nm, and more preferably 7 nm to 20 nm. Although the fine particles having a greater primary particle size have a higher effect of improving the sliding property of the film to be obtained, the fine particles are prone to decrease the transparency of the film. Therefore, the fine particles may be contained as secondary aggregates having a particle size of 0.05 μm to 0.3 μm. The sizes of the primary particles or secondary aggregates of the fine particles can be obtained by observing the primary particles or the secondary aggregates at a magnification of 500,000 times to 2,000,000 times with a transmission electron microscope, and calculating an average value of the particle sizes of the 100 primary particles or secondary aggregates.

The content of the fine particles is preferably 0.05 mass % to 1.0 mass %, and more preferably 0.1 mass % to 0.8 mass % based on the whole cellulose acetate including a low substitution degree component.

Physical Properties of Retardation Film

The retardation film of the present invention preferably includes a residual solvent therein in a certain amount or more in order to suppress the swelling of the retardation film when immersed in the saponifying solution. That is, the amount of the residual solvent in the retardation film of the present invention is preferably 700 mass ppm to 3,000 mass ppm, and more preferably 900 mass ppm to 200 mass ppm. Since water is prone to intrude between cellulose ester molecules when the amount of the residual solvent is less than 700 mass ppm, the retardation film is prone to swell when immersed in the saponifying solution. When the amount of the residual solvent is more than 3,000 mass ppm, on the other hand, since the strength of the film is low, a large conveyance tension cannot be applied to the film in a manufacturing process of a polarizing plate and also axis deviation tends to occur due to large shrinkage of the film caused by drying.

The amount of the residual solvent in the retardation film can be measured according to the following procedures.

(1) Preparation of Calibration Curve

After a sample including a solvent (for example, dichloromethane) at a known concentration is placed in a vial for exclusive use and the vial is sealed, the vial is set in a head space sampler. The vial is heated under the following head-space heating condition to produce a volatile component. The volatile component is measured by gas chromatography.

(Head Space Sampler)

Instrument: Head space sampler HP7694 type manufactured by Hewlett Packard Co.

Head-space heating condition: 20 minutes at 120° C.

(Gas Chromatography)

Instrument: 5971 type manufactured by Hewlett Packard Co.

Column: DB-624 manufactured by J&W Corporation

Detector: Flame ionization detector (FID)

GC temperature rising condition: After holding for 3 minutes at 45° C., the temperature is raised up to 100° C. at a rate of 8° C./min.

GC introduction temperature: 150° C.

A sample including a solvent (for example, dichloromethane) at a different concentration is also similarly measured. A peak area of the solvent in a GC chart obtained in each measurement is calculated, and the solvent concentration and the peak area are plotted to obtain a calibration curve. Similarly, the calibration curve of the other solvent (for example, methanol) is also prepared.

(2) Measurement of Amount of Residual Solvent in Retardation Film

Measurement is conducted by heating under the head-space heating condition in the same manner as in the procedure (1) except that the retardation film cut out in 10 cm square is fine-cut and the film pieces are placed in a vial for exclusive use and the vial is sealed, and the produced volatile component is measured by gas chromatography.

The peak area of each solvent is calculated from the obtained chart, and the amount of each residual solvent in the retardation film is obtained by collating the peak area with the calibration curve obtained in the procedure (1). The amount of the residual solvent of the retardation film is obtained as a mass rate (mass %) based on the whole film.

The residual solvent in the retardation film preferably contains dichloromethane and methanol. In order that the retardation film is less likely to absorb water, the residual solvent in the retardation film preferably has a dichloromethane content rate of 70 mass % to 90 mass %.

The retardation film of the present invention preferably has a small weight change ratio after the retardation film is stored under high temperature and high humidity conditions in order to suppress the swelling of the retardation film when the film is immersed in the saponifying solution. Specifically, a weight change ratio represented by the following Formula:

weight change ratio (%)=(M1−M0)/M0×100

is preferably −0.5% to 0.5%, and more preferably −0.25% to 0.25%, where a weight of the retardation film before storage is defined as M0 and a weight of the retardation film after storage at 80° C. and 90% RH for 120 hr is defined as M1.

In other words, when the film including the cellulose ester is stored under high temperature and high humidity conditions, the cellulose ester usually absorbs water to cause the hydrolysis thereof, and acetic acid to be produced is volatilized and removed to cause a decrease in the weight of the film; or the cellulose ester holds water to be prone to cause an increase in the weight of the film. On the other hand, the retardation film of the present invention having an absolute value of a weight change ratio of 0.5% or less is less likely to absorb or hold water.

Furthermore, a weight change ratio represented by the following Formula:

weight change ratio (%)=(M2−M0)/M0×100

is preferably −2% to −4%, and more preferably −2.5% to −3.5%, where a weight of the retardation film after storage at 80° C. and 90% RH for 300 hr is defined as M2.

The weight change ratio can be measured according to the following procedures.

(1) The retardation film is cut out in 25 cm square to prepare a sample film. A weight of the sample film (weight before storage) is measured at 23° C. and 55% RH.

(2) Next, the sample film is placed in a thermostatic chamber, and stored under the conditions of 80° C. and 90% RH for 120 hr or 300 hr. Then, the sample film is taken out from the thermostatic chamber, and left at 23° C. and 55% RH for 12 hours. Thereafter, a weight of the sample film (weight after storage) is measured at 23° C. and 55% RH.

(3) The weight of the sample film before storage and the weight of the sample film after storage are applied to the following Formula respectively to calculate a weight change ratio (%).

weight change ratio (%) after and before storage=(weight after storage−weight before storage)/(weight before storage)×100

The weight change ratio of the retardation film can be adjusted by the branching degree of the cellulose ester, the kind of the glass-transition-temperature lowering agent, the amount of the residual solvent, and the like. In order to decrease the weight change ratio of the retardation film, at least the branching degree (log [Iv(a)]/log [Mw(a)]) of the cellulose ester is preferably set to a certain level or more; and furthermore it is more preferable that the glass-transition-temperature lowering agent is contained and the amount of the residual solvent is set to 700 mass ppm or more.

For example, in order to subject a VA type liquid crystal cell to optical compensation, the retardation R₀ in the in-plain direction of the retardation film measured in a measurement wavelength of 590 nm under the conditions of 23° C. and 55% RH is preferably 10 nm to 100 nm, and more preferably 30 nm to 70 nm. The retardation Rth in the thickness direction of the retardation film measured in a measurement wavelength of 590 nm under the conditions of 23° C. and 55% RH is preferably 70 nm to 300 nm, and more preferably 90 nm to 230 nm.

The retardations R₀ and Rth can be adjusted by the total degree of substitution of acyl groups of the cellulose acetate, a stretching condition, and the like. In order to increase the retardation R₀, for example, the total degree of substitution of acyl groups of the cellulose acetate may be decreased, or a stretching magnification may be increased. In order to increase the retardation Rth, for example, a stretching temperature may be decreased, or a film thickness may be increased.

Retardation R₀ and Rth are respectively defined by the following formulas:

R₀=(nx−ny)×d (nm) Formula (I):

Rth={(nx+ny)/2−nz}×d (nm) Formula (II):

wherein in Formulas (I) and (II),

nx represents the refractive index in the slow axis direction x, at which the refractive index in the in-plane direction of the retardation film becomes maximum;

ny represents the refractive index in a direction y perpendicular to the slow axis direction x with respect to the in-plane direction of the retardation film;

nz represents the refractive index in the thickness direction z of the retardation film; and

d (nm) represents the thickness of the retardation film.

The retardations R₀ and Rth can be obtained by, for example, the following method.

(1) The humidity of the retardation film is controlled at 23° C. and 55% RH. The average refractive index of the retardation film after humidity control is measured by Abbe refractometer or the like.

(2) The retardation R₀ of the retardation film after humidity control, when light having a measurement wavelength of 590 nm is allowed to enter in parallel with the normal line of the surface of the film, is measured by KOBRA21ADH manufactured by Oji Scientific Instruments.

(3) With the in-plane slow axis of the retardation film taken as an inclination axis (rotation axis), a retardation value R (θ), when light having a measurement wavelength of 590 nm is allowed to enter from an angle (incident angle (θ)) of A to the normal line of the surface of the retardation film, is measured by KOBRA21ADH manufactured by Oji Scientific Instruments. The retardation value R (θ) can be measured at 6 points at intervals of 10 degrees in the range of 0 degree to 50 degrees. The in-plane slow axis of the retardation film can be confirmed by KOBRA21ADH manufactured by Oji Scientific Instruments.

(4) From the measured R₀ and R (θ) and the above average refractive index and film thickness, nx, ny, and nz are calculated by KOBRA21ADH, to calculate Rth in the measurement wavelength of 590 nm. Measurement of the retardation can be carried out under the conditions of 23° C. and 55% RH.

The angle θ1 (angle of orientation) formed by the in-plane slow axis of the retardation film and the width direction of the film is preferably from −1° to +1°, more preferably from −0.5° to +0.5°. Measurement of the angle of orientation θ1 of the retardation film can be carried out by using an automatic birefringence meter, KOBRA-WX (Oji Scientific Instruments Co., Ltd.).

The thickness of the retardation film is preferably 10 μm to 200 μm, more preferably 40 μm to 100 μm, and still more preferably 50 μm to 70 μm. When the thickness of the retardation film is more than 200 μm, variation in the retardation caused by heat or humidity is prone to increase. On the other hand, when the thickness of the retardation film is less than 10 μm, sufficient film strength and retardation are less likely to be obtained.

The haze (total haze) of the retardation film is preferably less than 1.0%. The haze (total haze) of the retardation film can be measured according to JIS K-7136 using a hazemeter (turbidity meter) (model number: NDH 2000, manufactured by Nippon Denshoku Industries Co., Ltd.). A halogen bulb of 5 V and 9 W may be used as a light source for the haze meter, and a silicon photocell (attached with a relative luminous efficiency filter) may be used as a light receiving section. All of measurement of the haze is carried out under the conditions of 23° C. and 55% RH.

The visible light transmittance of the retardation film is preferably 90% or more, and more preferably 93% or more.

Since the retardation film of the present invention contains a cellulose ester (for example, a cellulose ester having a matrix structure having a crosslinking point) having a branching degree of a certain level or more, the retardation film is less likely to take in water between cellulose ester molecules. The retardation film of the present invention is more hydrophobic than cellulose ester, contains a residual solvent in a certain amount or more, contains a glass-transition-temperature lowering agent having an SP value of 9.0 to 11.0, and hardly absorbs water. Thereby, the swelling (dimensional change) of the retardation film of the present invention when the film is immersed in the saponifying solution or the like can be suppressed.

2. Method for Producing Retardation Film

The retardation film can be produced by a solution casting method or a melt casting method. The retardation film can be preferably produced by the solution casting method.

A method for producing a retardation film including cellulose acetate according to a solution casting method includes (1) a step of dissolving at least cellulose acetate and the other additive, if needed, in a solvent to prepare a dope, (2) a step of casting the dope on an endless metal support, (3) evaporating the solvent from the cast dope to prepare a web, (4) a step of peeling the web from the metal support, (5) a step of drying and then stretching the web to obtain a film, and (6) a step of drying and winding up the obtained film.

1) Dope Producing Step

In a melting pot, cellulose acetate and other additives as necessary are dissolved in a solvent, and thus a dope is produced.

The solvents to be included in the dope may be used alone or in combination of two or more kinds. A good solvent and a poor solvent for cellulose acetate are preferably used in combination in the viewpoint of increasing manufacturing efficiency. The good solvent is defined as a solvent capable of dissolving cellulose acetate when used alone, and the poor solvent is defined as a solvent swelling cellulose acetate or being incapable of dissolving cellulose acetate when used alone. Therefore, the good solvent and the poor solvent are different depending on the total degree of substitution of acyl groups of the cellulose acetate (degree of substitution of acetyl groups).

When the good solvent and the poor solvent are used in combination, the amount of the good solvent is preferably more than that of the poor solvent in order to increase the solubility of the cellulose acetate. Regarding the mixing ratio of the good solvent and poor solvent, it is preferable that the mixing ratio of the good solvent is 70 mass % to 98 mass %, and the mixing ratio of the poor solvent is 2 mass % to 30 mass %.

Examples of the good solvent include organic halides such as dichloromethane; dioxolanes; acetone methyl acetate; and methyl acetoacetate. Preferred is dichloromethane. Examples of the poor solvent include methanol, ethanol, n-butanol, cyclohexane, and cyclohexanone, Preferred is methanol.

The concentration of cellulose acetate in the dope is preferably higher in order to reduce the drying load; however, if the concentration of cellulose acetate is too high, it is difficult to filter the dope. Therefore, the concentration of cellulose acetate in the dope is preferably 10 mass % to 35 mass %, and more preferably 15 mass % to 25 mass %.

Examples of the method of dissolving cellulose acetate in a solvent include a method of dissolving cellulose acetate in a solvent during heating under a higher pressure, a method involving adding a poor solvent to cellulose acetate to swell the cellulose acetate, and further adding a good solvent to dissolve the cellulose acetate, and a cooling dissolution method.

Among them, preferred is the method of dissolving cellulose acetate in a solvent during heating under a higher pressure, since the method enables heating to a boiling point or higher under a normal pressure. Specifically, the formation of a gel or insoluble agglomerate referred to as “Mamako” can be suppressed when stirring and dissolution are carried out while heating to a temperature which is the boiling point or higher of the solvent under a normal pressure in the range where the solvent do not boil under a higher pressure is carried out.

The heating temperature is preferably higher from the viewpoint of increasing the solubility of cellulose acetate, but if the temperature is too high, it is needed to increase the pressure, so that productivity is decreased. For this reason, the heating temperature is preferably 45° C. to 120° C., more preferably 60° C. to 110° C., and still more preferably 70° C. to 105° C.

The resultant dope may include, for example, insoluble materials such as the impurities included in the raw material cellulose acetate. These insoluble materials may serve as bright spot foreign matters for the resulting film. In order to remove these insoluble materials and the like, it is preferable to further filter the dope thus obtained.

2) Casting Step

This step includes sending the dope through a solution sending pump (for example, a pressurization-type metering gear pump) to a pressure die and casting the dope from a pressure die slit on an endless metal support (for example, a stainless belt or a rotary metal drum).

A preferable pressure die for which a slit shape of a mouthpiece is adjustable and which can easily adjust film thickness uniformly. Examples of the pressure die include a coat hanger die and a T-die. The surface of the metal support is preferably mirror surface-processed.

3) Solvent Evaporating Step

The web (dope film obtained by casting the dope on the metal support) is heated on the metal support, and thereby the solvent is evaporated.

The web is preferably dried in an atmosphere of 40° C. to 100° C. In order to dry the web in an atmosphere of 40° C. to 100° C., it is preferable to expose the upper surface of the web to hot air at 40° C. to 100° C. or heat the web by infrared rays or the like.

The solvent can be evaporated by a method of blowing air to the surface of the web, a method of transferring heat to the web from the back surface of a belt using a liquid, or a method of transferring heat to the web from the front and back surfaces using radiation heat. Preferred is the method of transferring heat to the web from the back surface of a belt using a liquid because of its high drying efficiency.

From the viewpoint of improving the surface quality, moisture permeability, peel properties, and the like of the web to be obtained, the web is preferably peeled from the metal support within 30 seconds to 120 seconds after casting.

4) Peeling Step

The web from which the solvent has been evaporated on the metal support is peeled at the peeling position on the metal support. The temperature at the peeling position on the metal support is preferably 10° C. to 40° C., and more preferably 11° C. to 30° C.

The amount of the residual solvent of the web when the web is peeled at the peeling position on the metal support is preferably 50 mass % to 120 mass % depending on drying conditions, the length of the metal support, and the like. A web including a larger amount of residual solvents is too soft, and likely to lose flatness. The web is prone to generate wrinkles extending in a lengthwise direction due to a peel tension. The amount of the residual solvent of the web at the peeling position can be set so that the wrinkles extending in the lengthwise direction can be suppressed. The amount of residual solvent of the web is defined by the following formula:

Amount of residual solvent (%)=(mass of web before heat treatment−mass of web after heat treatment)/(mass of web after heat treatment)×100

Meanwhile, the heat treatment used when the amount of residual solvent is measured means a heat treatment at 115° C. for one hour.

When the web includes the glass-transition-temperature lowering agent, the amount of the residual solvent in the web when the web is peeled from the metal support is preferably decreased to a certain amount or less in order to unevenly distribute the glass-transition-temperature lowering agent in a film thickness direction in the retardation film to be obtained, and thereby the amount of the solvent on a surface of the web which is not brought into contact with the metal support is sufficiently decreased. Specifically, the amount of the residual solvent in the web may be preferably 90 mass % or less, more preferably 85 mass % or less, and still more preferably 80 mass % or less.

The amount of the residual solvent of the web may be adjusted by a drying temperature or a drying time. For example, in order to set the amount of the residual solvent of the web including the glass-transition-temperature lowering agent to the above range, the drying temperature is preferably about 25° C. to about 50° C., and more preferably about 35° C. to about 45° C. The drying time may be preferably about 15 seconds to about 150 seconds.

A peel tension when the web is peeled from the metal support may be usually 300 N/m or less.

5) Drying and Stretching Step

The web obtained by peeling from the metal support is dried, and then is stretched. Regarding the drying of the web, the web may be dried while conveying the web using a number of rolls disposed vertically, or may be dried while conveying the web in a state of having the two edges of the web fixed with clips.

The method for drying the web is desirably a method of drying with hot air, infrared radiation, a heated roll, microwaves, and the like, and in view of being simple, a method of drying with hot air is preferred. The drying temperature of the web may be about 40° C. to about 250° C., and preferably about 40° C. to about 160° C.

By stretching the web, a retardation film having a desired retardation is obtained. The retardation of the retardation film can be controlled by adjusting the magnitude of the tension applied to the web.

The web is stretched in a width direction (TD direction), a casting direction (MD direction) of the dope, or an oblique direction. The web is preferably stretched in at least the width direction (TD direction). Stretching of the web may be carried out by uniaxial stretching, or by biaxial stretching. Biaxial stretching is preferably stretching in the casting direction (MD direction) and width direction (TD direction) of the dope. Biaxial stretching may be sequential biaxial stretching, or may be simultaneous biaxial stretching.

Examples of the sequential biaxial stretching include a method of sequentially carrying out stretching in different stretching directions, and a method of carrying out stretching in the same direction in multiple stages. Examples of the sequential biaxial stretching include the following stretching steps.

Stretching in the casting direction (MD direction)-Stretching in the width direction (TD direction)-Stretching in the casting direction (MD direction)-Stretching in the casting direction (MD direction)

Stretching in the width direction (TD direction)-Stretching in the width direction (TD direction)-Stretching in the casting direction (MD direction)-Stretching in the casting direction (MD direction)

The simultaneous biaxial stretching also includes an aspect in which the film is stretched in one direction and contracted in the other direction with tension relaxed.

Depending on the thickness of the retardation film to be obtained and the desired retardation value, finally, a stretching magnification in the casting direction may be 0.8 times to 1.5 times, and preferably 0.8 times to 1.1 times; and a stretching magnification in the width direction may be 1.1 times to 2.0 times, and preferably 1.3 times to 1.7 times.

The stretching temperature of the web may be preferably set to 120° C. to 200° C., more preferably to 150° C. to 200° C., and even more preferably to higher than 150° C. and 190° C. or lower.

The method for stretching the web is not particularly limited, and a method of producing differences in the circumferential speed in a plurality of rolls, and stretching in the casting direction (MD direction) by utilizing the differences in the roll circumferential speed among the rolls (roll stretching method); a method of fixing two edges of the web with clips or pins, and extending the distance between the clips or pins toward the casting direction (MD direction) to stretch the web in the casting direction (MD direction), or extending the distance in the width direction (TD direction) to stretch the web in the width direction (TD direction), or extending the distance in both the casting direction (MD direction) and the width direction (TD direction) to stretch the web in both the casting direction (MD direction) and the width direction (TD direction) (tenter stretching method); and the like may be used. These stretching methods may be used in combination.

The residual solvent in the web at the time of initiation of stretching may be adjusted preferably to 20 mass % or less, and more preferably to 15 mass % or less.

(6) Step of Drying Film and Thereafter Winding Film

In order to decrease the amount of the residual solvent of the retardation film, the film to be obtained after stretching is further preferably dried. A drying temperature may be 140° C. or less, preferably about 100° C. to about 120° C. When the drying temperature is too low, the solvent is less likely to be sufficiently evaporated and removed. When the drying temperature is too high, on the other hand, the amount of the residual solvent of the film is excessively decreased. A method for drying the film may be a method of applying hot air while conveying a film, or the like, for example.

The retardation film is wound in a direction perpendicular to the width direction of the film using a rolling-up machine, and thereby a wound body can be obtained.

3. Polarizing Plate

The polarizing plate of the present invention includes a polarizer, and the retardation film of the present invention that is disposed on at least one surface of the polarizer. The retardation film of the present invention may be disposed directly on the polarizer, or may be disposed with another film or layer interposed therebetween.

The polarizer is an element which permits passage of light polarized in a certain direction alone. The polarizer is a polyvinyl alcohol-based polarizing film, and preferably a polyvinyl alcohol-based uniaxially-stretched film stained with iodine, a dichromatic dye, or the like.

The stained polyvinyl alcohol-based uniaxially-stretched film may be a polyvinyl alcohol-based film uniaxially stretched and then stained with iodine or a dichromatic dye; or may be a polyvinyl alcohol-based film stained with iodine or a dichromatic dye and then uniaxially stretched. The uniaxial stretching can be performed so that the final stretching magnification is about 5 times.

The polyvinyl alcohol-based film may be a film produced from a polyvinyl alcohol aqueous solution. As the polyvinyl alcohol-based film, an ethylene-modified polyvinyl alcohol film is preferable as it has excellent polarizing performance and durability performance, and minimal color spotting. Examples of the ethylene-modified polyvinyl alcohol film include films having an ethylene unit content of 1 mol % to 4 mol %, a degree of polymerization of 2,000 to 4,000, and a degree of saponification of 99.0 mol % to 99.99 mol % as described in Japanese Patent Application Laid-Open Nos. 2003-248123 and 2003-342322.

Examples of the dichromatic dye include an azo-based dye, a stilbene-based dye, a pyrazolone-based dye, a triphenylmethane-based dye, a quinoline-based dye, an oxazine-based dye, a thiazine-based dye, and an anthraquinone-based dye.

After the polyvinyl alcohol-based film or the polyvinyl alcohol-based uniaxially-stretched film is stained with iodine or a dichromatic dye, the film is preferably further processed with a boron compound in order to promote fixing of the iodine or the dichromatic dye. Preferable examples of the boron compound include boric acid.

The thickness of the polarizer is, but is not particularly limited to, about 2 μm to about 30 μm, and preferably 10 μm or less in order to decrease the thickness of the polarizing plate.

When the retardation film of the present invention is disposed only on one surface of the polarizer, other transparent protective film may be disposed on the other surface of the polarizer. Examples of the transparent protective film include a cellulose ester film. Examples of cellulose ester films that are preferably used include commercially available cellulose ester films (for example, Konica Minolta TAC KC8UX, KC5UX, KC8UCR3, KC8UCR4, KC8UCR5, KC8UY, KC6UY, KC4UY, KC4UE, KC8UE, KC8UY-HA, KC8UX-RHA, KC8UXW-RHA-C, KC8UXW-RHA-NC, and KC4UXW-RHA-NC, all manufactured by Konica Minolta Opto, Inc.).

The thickness of the transparent protective film is not particularly limited, but may be adjusted to about 10 μm to 200 μm, and the thickness may be preferably 10 μm to 100 μm, and more preferably 10 μm to 70 μm.

The polarizing plate of the present invention preferably satisfies both the following Formulas (a) and (b):

40≦F≦100 (a)

6≦F/P≦16, (b)

where the thickness of the polarizer is defined as P (μm) and the thickness of the retardation film of the present invention is defined as F (μm).

The polarizing plate of the present invention can be produced by pasting a polarizer and the retardation film of the present invention together using an adhesive, for example. The thickness P (μm) of the polarizer and the thickness F (μm) of the retardation film of the present invention preferably satisfy the above ranges.

When the polarizer is thin and has a thickness of 10 μm or less, for example, the polarizer to be pasted on the retardation film may be a resin layer (PVA layer) disposed on a base film. In this case, the base film may be peeled from the resin layer (PVA layer) after the polarizer and the retardation film of the present invention are pasted together using an adhesive.

For the adhesive used for the pasting, for example, an aqueous solution of a fully saponified polyvinyl alcohol, or the like is preferably used. It is preferable that the retardation film to be pasted is immersed in the saponifying solution (for example, alkaline aqueous solution) or the saponifying solution is applied to the retardation film, to subject the retardation film to saponification treatment in order to improve adhesiveness to the polarizer.

Meanwhile, the retardation film of the present invention has decreased swelling (dimensional change) when immersed in the saponifying solution. Therefore, the axis deviation of the retardation film subjected to saponification treatment and polarizer can be suppressed. When the retardation film of the present invention and a thin polarizer are pasted together, the warpage or the like of a polarizing plate to be obtained is less likely to occur.

Furthermore, in order to improve the adhesiveness between the retardation film and the polarizer, the cellulose ester (included in the retardation film) and the boron compound included in the polarizer are preferably present at the interface between the retardation film and the polarizer.

Meanwhile, since the retardation film of the present invention includes the cellulose ester having a branching degree of a certain level or more (for example, the cellulose ester having a matrix structure having a crosslinking point), the glass-transition-temperature lowering agent is less likely to move to the surface of the film, and the cellulose ester on the surface of the retardation film (the adhesion interface with the polarizer) is likely to be activated. Since the retardation film of the present invention includes a large amount of residual solvents, the boron compound (preferably, boric acid) included in the polarizer is likely to move to the adhesion interface between the retardation film and the polarizer. Thereby, the cellulose ester and the boron compound are present at the interface between the polarizer and the retardation film, and sufficiently interacted with each other to enable formation of a crosslinked structure (boric acid crosslinking). Therefore, even when a saponification treatment time is shortened, the retardation film can be satisfactorily adhered to the polarizer.

4. Liquid Crystal Display Device

A liquid crystal display device of the present invention includes a liquid crystal cell and a pair of polarizing plates holding the liquid crystal cell.

The liquid crystal cell includes an array substrate including a thin film transistor, a counter substrate, and a liquid crystal layer disposed between the array substrate and the counter substrate and including liquid crystal molecules. There are no particular limitations on the display system of the liquid crystal cell, and examples include a TN (Twisted Nematic) system, a STN (Super Twisted Nematic) system, an IPS (In-Plane Switching) system, an OCB (Optically Compensated Birefringence) system, a VA (Vertical Alignment) system, (also including MVA; Multi-domain Vertical Alignment, and PVA; Patterned Vertical Alignment), and a HAN (Hybrid Aligned Nematic) system. Since the contrast is increased and so on, a VA (MVA or PVA) system is preferred.

The array substrate includes a thin film transistor and a pixel electrode connected to the thin film transistor. The counter electrode may be provided on the array substrate, or may be provided on the counter substrate.

A color filter may be disposed on the array substrate or the counter substrate. However, the color filter is preferably disposed on the array substrate in order to improve the aperture ratio of the liquid crystal cell.

The liquid crystal layer includes liquid crystal molecules having negative or positive dielectric anisotropy. When the pixel electrode is disposed on one transparent substrate and the counter electrode is disposed on the other transparent substrate, the liquid crystal molecules included in the liquid crystal layer preferably have negative dielectric constant anisotropy. When both the pixel electrode and the counter electrode are disposed on one transparent substrate, the liquid crystal molecules included in the liquid crystal layer preferably have positive dielectric constant anisotropy.

In a liquid crystal cell configured as such, an electric field is generated between the pixel electrode and the counter electrode by applying an image signal (voltage) to the pixel electrode. Thereby, the liquid crystal molecules that are oriented vertically to the surface of the transparent substrate are oriented such that the major axes thereof come in parallel direction (horizontal direction) with respect to the surface of the transparent substrate. As such, the liquid crystal layer is driven, and the transmittance and reflectance of the various sub-pixels are changed to implement image display.

At least one of the pair of polarizing plates is the polarizing plate of the present invention. The polarizing plate of the present invention includes the polarizer and the retardation film of the present invention disposed on the surface of the polarizer facing the liquid crystal cell.

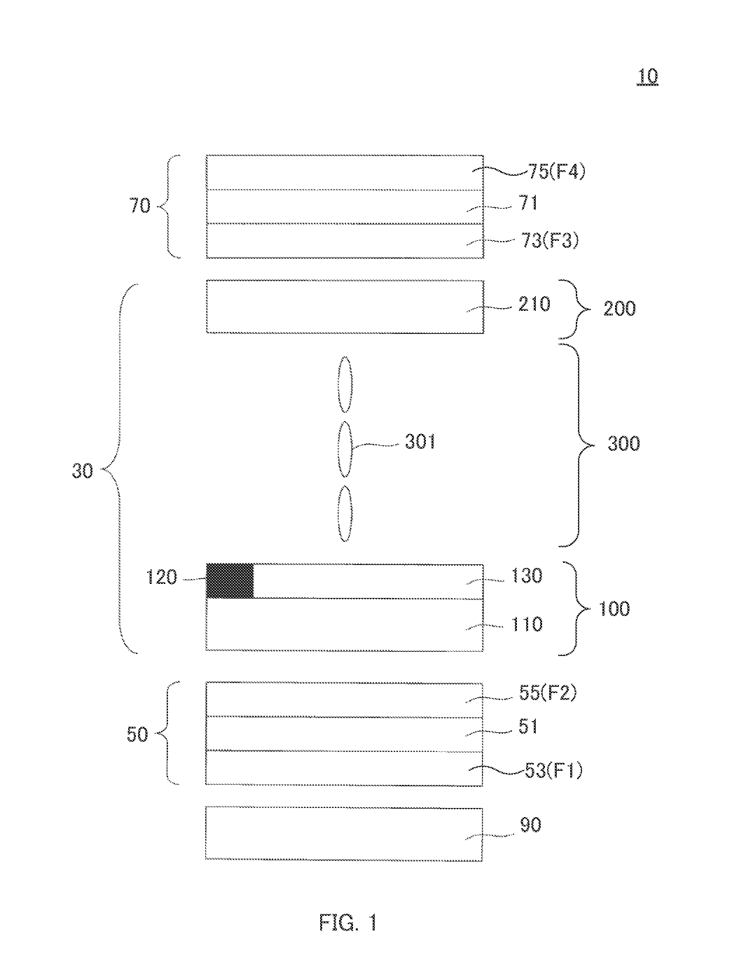

FIG. 1 is a schematic view showing an example of a constitution of a VA type liquid crystal display device. As shown in FIG. 1, liquid crystal display device 10 includes liquid crystal cell 30, first polarizing plate 50 and second polarizing plate 70 holding the liquid crystal cell 30, and backlight 90.

Liquid crystal cell 30 includes array substrate 100, counter substrate 200, and liquid crystal layer 300 disposed between array substrate 100 and counter substrate 200 and including liquid crystal molecules 301. Array substrate 100 includes transparent substrate 110, thin film transistor 120, pixel electrode (not shown) connected to thin film transistor 120, and color filter 130. That is, liquid crystal cell 30 has a COA structure (color filter-on-array structure).

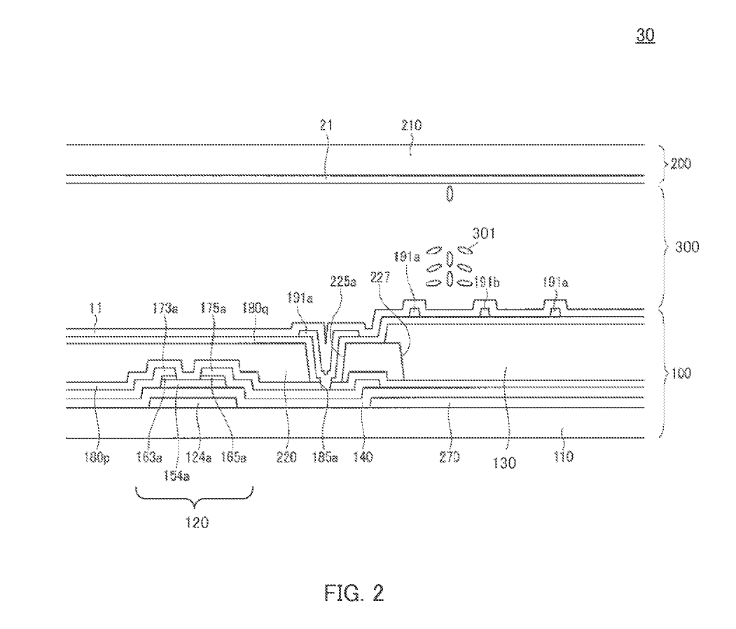

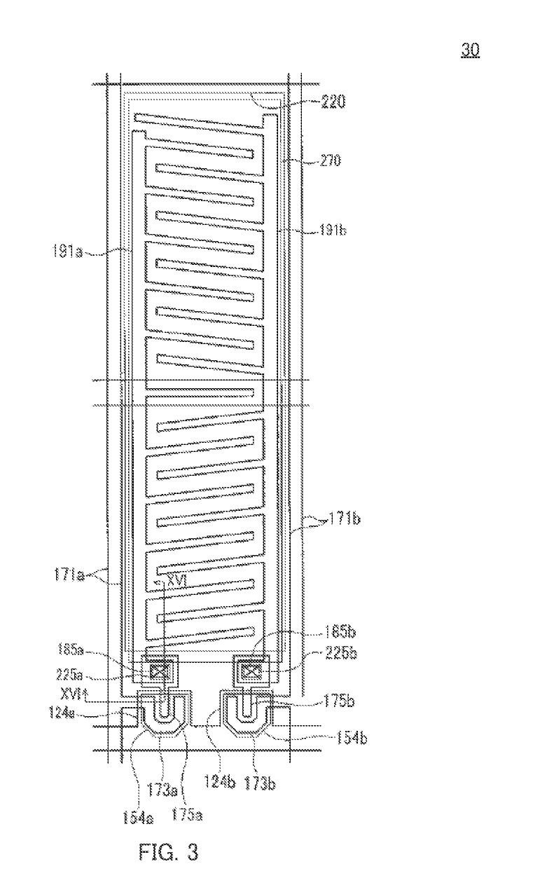

FIGS. 2 and 3 are schematic views showing an example of a preferable constitution of a liquid crystal cell having a COA structure. FIG. 2 is a sectional view of a liquid crystal cell laminate having a COA structure. FIG. 3 is a top view of array substrate 100 of the liquid crystal cell having a COA structure (see FIG. 2). The sectional view of the laminate shown in FIG. 2 is a sectional view taken along line XVI-XVI of FIG. 3.

As shown in FIG. 2, liquid crystal cell 20 has array substrate 100, counter substrate 200, and liquid crystal layer 300 held between array substrate 100 and counter substrate 200.

As shown in FIGS. 2 and 3, array substrate 100 includes common electrode 270, pixel electrode 191a (pixel electrode), and pixel electrode 191b (counter electrode) which are provided on transparent substrate 110. Pixel electrodes 191a and 191b are alternately disposed in a strip form on transparent substrate 110. Common electrode 270 is planarly disposed on transparent substrate 110. Pixel electrodes 191a and 191b, and common electrode 270 overlap (see FIG. 3).

Transparent substrate 110 is made of transparent glass or resin.

As shown in FIG. 2, array substrate 100 includes thin film transistor 120, and pixel electrodes 191a and 191b which are provided on transparent substrate 110. Pixel electrode 191a is connected to drain electrode 175a of thin film transistor 120. Similarly, pixel electrode 191b is connected to drain electrode 175b of thin film transistor 120 (not shown in FIG. 2). As shown in FIG. 3, thin film transistor 120 connected to each pixel electrode is disposed at the corner of each pixel.

As shown in FIG. 2, thin film transistor 120 includes gate electrode 124a, gate insulator film 140, island semiconductor 154a, first and second island ohmic contact members (163a and 165a), source electrode 173a, and drain electrode 175a. Source electrodes (173a, 173b) are respectively connected to data lines (171a, 171b) transmitting data signals (see FIG. 3).

Thin film transistor 120 is covered with lower protective membrane 180p, and light blocking member 220 or color filter 130 is disposed on lower protective membrane 180p. Light blocking member 220 or color filter 130 is further covered with upper protective membrane 180q. Pixel electrode 191a is disposed on a part of upper protective membrane 180q. Pixel electrode 191a is connected to drain electrode 175a through contact hole 185a formed in lower protective membrane 180p and upper protective membrane 180q. Furthermore, upper protective membrane 180q and pixel electrode 191a are covered with oriented film 11. Symbol 225a designates a through-hole and symbol 227 designates an opening part of light blocking member 220.

Counter substrate 200 includes transparent substrate 210 and oriented film 21. Transparent substrate 210 is made of transparent glass or resin as in transparent substrate 110.

Liquid crystal molecules 301 included in liquid crystal layer 300 are preferably made of a nematic liquid crystal material (p type nematic liquid crystal material) having positive dielectric anisotropy.

When a common voltage is applied to common electrode 270 and data voltages different from each other in polarity are applied to pixel electrodes (191a, 191b) in liquid crystal cell 30 thus constituted, an electric field which is substantially horizontal to the surface of transparent substrate 110 or 210 is generated. Thereby, liquid crystal molecules 301 oriented perpendicularly to the surface of transparent substrate 110 or 210 when no voltage is applied respond to the electric field so that the long axes of liquid crystal molecules 301 are oriented in a direction horizontal to the surface of transparent substrate 110 or 210. Therefore, an image can be displayed on a display screen of the liquid crystal display device.

First polarizing plate 50 is disposed on the surface of liquid crystal cell 30 facing backlight 90. First polarizing plate 50 includes first polarizer 51, protective film 53 (F1) disposed on the surface of first polarizer 51 facing backlight 90, and protective film 55 (F2) disposed on the surface of first polarizer 51 facing liquid crystal cell 30. Second polarizing plate 70 is disposed on the visible side surface of liquid crystal cell 30. Second polarizing plate 70 includes second polarizer 71, protective film 73 (F3) disposed on the surface of second polarizer 71 facing liquid crystal cell 30, and protective film 75 (F4) disposed on the visible side surface of second polarizer 71. At least one of protective films 55 (F2) and 73 (F3) is the retardation film of the present invention.

The absorption axis of first polarizer 51 and the in-plane slow axis of protective film 55 (F2) are orthogonal to each other; and the absorption axis of second polarizer 71 and the in-plane slow axis of protective film 73 (F3) are orthogonal to each other.

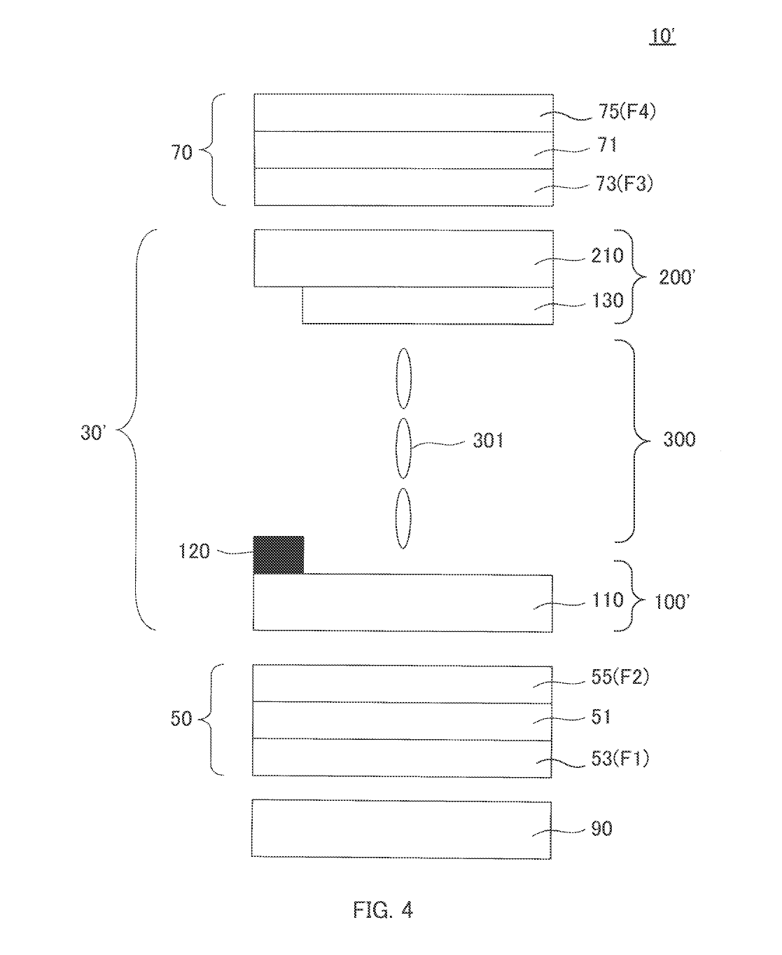

FIG. 4 is a schematic view showing another example of a constitution of a VA type liquid crystal display device. As shown in FIG. 4, liquid crystal display device 10′ may be constituted as in FIG. 1 except that liquid crystal cell 30′ is used in place of liquid crystal cell 30.

Liquid crystal cell 30′ includes array substrate 100′, counter substrate 200′, and liquid crystal layer 300 disposed between array substrate 100′ and counter substrate 200′ and including liquid crystal molecules 301. In array substrate 100′, thin film transistor 120 and pixel electrode (not shown) connected to thin film transistor 120 are disposed on transparent substrate 110; and in counter substrate 200′, color filter 130 is disposed on transparent substrate 210.

The aperture ratio of the liquid crystal display device is preferably 57% or more, and more preferably 65% or more.

Since the absorption axis of the polarizer and the slow axis of the retardation film of the present invention in the polarizing plate of the present invention are orthogonal to each other with high precision, the liquid crystal display device of the present invention including the polarizing plate can provide a decreased color shift. Particularly, the color shift is almost inconspicuous even in the liquid crystal display device having a high aperture ratio as shown in FIG. 1.

### EXAMPLES

Hereinafter, the present invention will be described in more detail with reference to Examples. The scope of the present invention should not be interpreted in a limited manner by these Examples.

Materials used for synthesis of cellulose acetate will be shown below.

(1) Cellulose

Pulp 1: Kraft-based dissolving pulp (α-cellulose content rate: 95 mass %)

Pulp 2: Pulp (α-cellulose content rate: 92 mass %)

(2) Second sugar

Xylose: Xylose manufactured by Tokyo Chemical Industry Co., Ltd. (>98.0% LC)

Xylan: Xylan manufactured by Tokyo Chemical Industry Co., Ltd. (from birchwood)

Mannose: Mannose manufactured by Tokyo Chemical Industry Co., Ltd. (>98.0% GC)

Mannan: Mannan manufactured by Tokyo Chemical Industry Co., Ltd. (from yeast) Glucomannan: Glucomannan manufactured by Wako Pure Chemical Industries, Ltd.

### 1. Synthesis of Cellulose Acetate

### Synthesis Example 1

A kraft-based dissolving pulp (α-cellulose content rate: 95%) was disintegrated in water, and dried via acetone substitution. For 100 parts by mass of the obtained pulp, 500 parts by mass of acetic acid was uniformly sprayed, and mixed at 40° C. for 30 minutes to activate the pulp (activation step).

To the activated pulp, 2 parts by mass of xylan and 1 part by mass of xylose were added (crosslinking step). A mixture of 250 parts by mass of acetic anhydride and 14.0 parts by mass of sulfuric acid was further added thereto for esterification according to an ordinary method (acetylation step). Heat was produced by the reaction of water included in the pulp with the acetic anhydride and the reaction of the cellulose with the acetic anhydride, and the reaction was cooled from outside.

To the obtained reaction product, 35 parts by mass of a 20% calcium acetate aqueous solution was added over 2 minutes so that an amount of sulfuric acid (aging sulfuric acid amount) in the reaction product became 2.5 parts by weight. To the obtained reaction product, water at about 100° C. was further added under the atmospheric pressure to set an amount of moisture (aging moisture amount) in the reaction product to 40 mol %, and the reaction product was held for 50 minutes (saponification-aging step). A diluted acetic acid aqueous solution was further added to the reaction product, and separated as flake-like cellulose acetate. The obtained flake-like cellulose acetate was sufficiently washed with water, and then dried to obtain cellulose acetate A.

### Synthesis Examples 2 to 6

Cellulose acetates B to F were obtained in the same manner as in Synthesis Example 1 except that an addition amount of xylan, xylose, mannan, mannose, or glucomannan in an addition step, an acetylation temperature in an acetylation step, an aging condition in a saponification-aging step, and the like were changed as shown in Table 1.

### Synthesis Examples 7 to 10

Cellulose acetates G to J were synthesized in the same manner as in Synthesis Example 1 except that pulp (α-cellulose content rate: 95%) was changed to pulp (α-cellulose content rate: 92%) containing 2 mass % of xylan, and an addition amount of xylan, xylose, mannan, mannose, or glucomannan in an addition step, an acetylation temperature in an acetylation step, and an aging condition in a saponification-aging step were changed as shown in Table 1.

The branching degree of the obtained cellulose acetate was measured by the following method.

(Branching Degree of Cellulose Acetate)

(1) Pretreatment

0.1 g of the synthesized cellulose acetate and 10 ml of THF were placed in a 20 ml test tube, and dissolved at 25° C. for 4 hours. The obtained solution was filtered through a simple treatment filter (MYSHORIDISK H-25-2 having a pore size of 0.2 μm or more and 0.5 μm or less (manufactured by Tosoh Corporation)) to obtain a solution sample for GPC-LALLS-viscosity measurement.

(2) Main Measurement

The obtained solution sample was subjected to GPC-LALLS-viscosity measurement under the following conditions.

(Measurement Conditions)

Apparatus: HLC-8220GPC manufactured by Tosoh Corporation

Columns: TSK-GEL (R) Super AWM-Hx2 (manufactured by Tosoh Corporation)

Detector: Model302 manufactured by Viscotek (a triple detector including a refractive-index meter, a scattering intensity meter, and a viscometer (4 capillary (bridge type) differential pressure viscometer) as detectors)

Solution sending temperature: 40° C.

Solvent: THF

Flow rate: 0.4 ml/min

Injection volume: 500 μl

A plot of a common logarithm log [Mw] of an absolute molecular weight (Mw) on the abscissa axis versus a common logarithm log [Iv(a)] of a viscosity Iv(a) on the ordinate axis was obtained through the GPC-LALLS-viscosity measurement. The plot was obtained by Mark-Houwink plot using an analysis software included in a main unit for the arbitrary specifyed analysis range. The slope a(log [Iv(a)]/log [Mw]) of the obtained plot was obtained. The slope a of the plot was obtained by subjecting the plot in the range of log [Mw] of 5.2 to 5.8 to linear approximation.

The synthesis conditions of Synthesis Examples 1 to 10 are shown in Table 1; and the physical properties of the cellulose ester obtained in Synthesis Examples 1 to 10 are shown in Table 2.

TABLE 1

| | raw | | second sugar | | | | | | | | |
|---|---|---|---|---|---|---|---|---|---|---|---|
| | material cellulose | | Xylan | Xylose | Mannan | Mannose | Glucomannan | process condition | | | |
| | | α-cellulose | content | content | content | content | content | | acetylation | aging | aging |
| | | content | (part by | (part by | (part by | (part by | (part by | addition | temperature | moisture | time |
| | kind | (%) | weight) | weight) | weight) | weight) | weight) | timing | (20 C.) | (mol %) | (min) |
| Synthesis | pulp | 95 | 2 | 1 | 0 | 0 | 0 | after | 50 | 40 | 50 |
| Example 1 | | | | | | | | activating | | | |
| Synthesis | pulp | 95 | 2 | 0 | 0 | 0 | 0 | after | 50 | 40 | 40 |
| Example 2 | | | | | | | | activating | | | |
| Synthesis | pulp | 95 | 2 | 1 | 0 | 1 | 0 | after | 50 | 40 | 100 |
| Example 3 | | | | | | | | activating | | | |
| Synthesis | pulp | 95 | 2 | 0 | 1 | 1 | 0 | after | 55 | 40 | 52 |
| Example 4 | | | | | | | | activating | | | |
| Synthesis | pulp | 95 | 1 | 0 | 0 | 1 | 0 | after | 50 | 40 | 48 |
| Example 5 | | | | | | | | activating | | | |
| Synthesis | pulp | 95 | 2 | 1 | 0 | 1 | 0 | after | 50 | 40 | 60 |
| Example 6 | | | | | | | | activating | | | |
| Synthesis | pulp | 92 | 2 | 0 | 0 | 0 | 0 | after | 40 | 60 | 50 |
| Example 7 | | | | | | | | activating | | | |
| Synthesis | pulp | 92 | 0 | 0 | 0 | 0 | 1.5 | after | 40 | 60 | 50 |
| Example 8 | | | | | | | | activating | | | |
| Synthesis | pulp | 92 | 2 | 0 | 0 | 0 | 0 | before | 40 | 60 | 50 |
| Example 9 | | | | | | | | activating | | | |
| Synthesis | pulp | 92 | 3 | 2 | 3 | 2 | 5.5 | after | 55 | 40 | 50 |
| Example 10 | | | | | | | | activating | | | |

TABLE 2

| | cellulose ester | | | | | |
|---|---|---|---|---|---|---|
| | | | | absolute molecular | weight average molecular | number average molecular |
| | | degree of | | weight | weight | weight |
| | kind | substitution | logIv/logMw | (×10⁵) | (×10⁴) | (×10⁴) |
| Synthesis Example 1 | A | 2.4 | 0.73 | 1.2 | 20 | 8.0 |
| Synthesis Example 2 | B | 2.6 | 0.7 | 1.3 | 21 | 8.3 |
| Synthesis Example 3 | C | 1.8 | 0.74 | 2.5 | 25 | 7.2 |
| Synthesis Example 4 | D | 2.39 | 0.82 | 1.4 | 22 | 8.1 |
| Synthesis Example 5 | E | 2.39 | 0.67 | 1.6 | 21 | 7.9 |
| Synthesis Example 6 | F | 2.2 | 0.73 | 2.1 | 24 | 7.4 |
| Synthesis Example 7 | G | 2.4 | 0.76 | 1.3 | 23 | 8.2 |
| Synthesis Example 8 | H | 2.4 | 0.8 | 1.2 | 21 | 8.5 |
| Synthesis Example 9 | I | 2.41 | 0.55 | 1.4 | 20 | 8.5 |
| Synthesis Example 10 | J | 2.38 | 0.99 | 1.2 | 21 | 8.5 |

Tables 1 and 2 show that all the cellulose esters of Synthesis Examples 1 to 8 and 10 in which a second sugar is added to the activated cellulose have a high branching degree of 0.65 or more. Tables 1 and 2 show that the cellulose ester of Synthesis Example 9 in which the second sugar is added to the non-activated cellulose has, on the other hand, a low branching degree of less than 0.65.

### 2. Other Materials

(1) Additives

TPP: Triphenyl phosphate (SP value: 10.7)

Polyester compound: a polyester compound represented by the following chemical formula (SP value: 10.1)

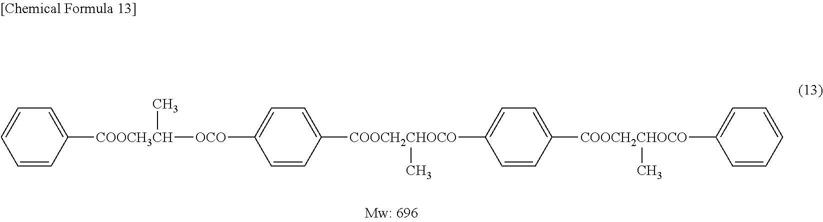

PETB: Pentaerythritoltetrabenzoate (SP value: 11.5)

Triazine compound: a triazine compound represented by the following chemical formula

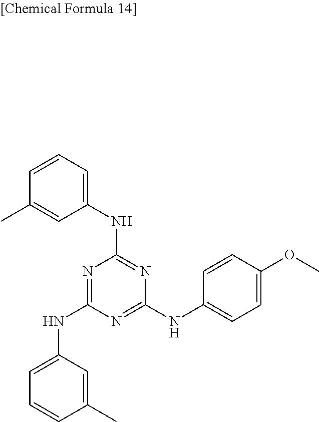

The SP values of the materials were calculated according to the calculation method described in a reference document, pages 54-57 of “Basic Science for Coating” by Yuji Harada, published by Maki Shoten (1977).

### 3. Production of Retardation Film

### Example 1

### Preparation of Fine Particle Additive Liquid 1

The components described below were mixed with stirring for 50 minutes with a dissolver, and then the mixture was dispersed with a Manton Gaulin homogenizer. Thus, fine particle dispersion liquid 1 was obtained.

(Composition of Fine Particle Dispersion Liquid 1)

Fine particles (AEROSIL R972V, manufactured by Nippon Aerosil Co., Ltd.): 11 parts by mass

Methanol: 89 parts by mass

Fine particle dispersion liquid 1 thus obtained was slowly added with sufficient stirring to a dissolving tank containing dichloromethane. The solution thus obtained was dispersed with Attritor such that the particle size of secondary particles of the fine particles would be a predetermined size, and then the dispersion was filtered in FINEMET NF manufactured by Nippon Seisen Co., Ltd. Thus, fine particle additive liquid 1 was obtained.

(Composition of Fine Particle Additive Liquid 1)

Dichloromethane: 99 parts by mass

Fine particle dispersion liquid 1:5 parts by mass

Then, dichloromethane, methanol, and water in an amount set so that a water content in a dope liquid was 1.6 mass % were charged into a pressurization dissolving tank. The cellulose acetate obtained in Synthesis Example 1, triphenyl phosphate, and the fine particle additive liquid 1 were further charged into the pressurization dissolving tank while being stirred, and completely dissolved while being stirred under heating. The obtained solution was charged into a main melting pot and the main melting pot was sealed. The solution was further dissolved while being stirred to obtain a dope liquid 1.

(Composition of Dope Liquid 1)

Dichloromethane (SP value: 9.7): 340 parts by mass

Methanol (SP value: 12.7): 64 parts by mass

Water: an amount set so that the content of water in the dope liquid was 1.6 mass %

Cellulose acetate A (degree of substitution of acetyl groups Dac=2.40, log [Iv]/log [Mw]=0.73):100 parts by mass

Triphenyl phosphate (TPP): 10 parts by mass

Fine particle addition liquid 1:1 part by mass

The obtained dope liquid 1 was uniformly cast at a width of 1,800 mm onto a stainless-band support at a temperature adjusted to 35° C. using a belt casting apparatus. The solvent in the obtained dope film was evaporated on the stainless-band support until the amount of the residual solvent became 88 mass %. Then, the dope film was peeled from the stainless-band support at a peel tension of 130 N/m to obtain a web. The solvent included in the obtained web was further evaporated at 55° C. Then, the resulting web was slit into a width of 1,650 mm.

The obtained web was stretched by 40% in the width direction (TD direction) of the web at 155° C. using a tenter stretching machine. The amount of the residual solvent of the web at the start of stretching was 4.6 mass %.

The obtained film was dried at 110° C. for 11 minutes while being conveyed by a large number of rolls, to obtain film 101 having a film thickness of 60 μm

### Examples 2 to 4

Retardation films 102 to 104 were obtained in the same manner as in Example 1 except that drying conditions of films were changed as shown in Table 3.

### Examples 5 and 6

Retardation films 105 and 106 were obtained in the same manner as in Example 2 except that kinds of additives were changed as shown in Table 3.

### Examples 7 to 11

Retardation films 107 to 111 were obtained in the same manner as in Example 6 except that kinds of cellulose acetates and drying conditions were changed as shown in Table 3.

### Examples 12 and 13

Retardation films 112 and 113 were obtained in the same manner as in Example 6 except that film thicknesses and drying conditions were changed as shown in Table 3.

### Comparative Example 1

Retardation film 114 was obtained in the same manner as in Example 1 except that a drying condition of a film was changed as shown in Table 3.

### Comparative Examples 2 to 5

Retardation films 115 to 118 were obtained in the same manner as in Example 1 except that kinds of cellulose acetates and additives were changed as shown in Table 3.

### Comparative Examples 6 and 7

Retardation films 119 and 120 were obtained in the same manner as in Example 1 except that kinds of additives and drying conditions were changed as shown in Table 3.

The amount of the residual solvents and weight change ratios of the obtained films were measured by the following methods.

(Amount of the Residual Solvent)

(1) Preparation of Calibration Curve

A sample having a known methanol concentration was placed in a vial for exclusive use and the vial was sealed with a septum and an aluminum cap. The vial was set in a head space sampler. The vial was heated under the following head-space heating condition, to produce a volatile component. The volatile component was measured by gas chromatography.

(Head Space Sampler)

Instrument: Head space sampler HP7694 type manufactured by Hewlett Packard Co.

Head-space heating condition: 20 minutes at 120° C.

(Gas Chromatography)

Instrument: 5971 type manufactured by Hewlett Packard Co.

Column: DB-624 manufactured by J&W Corporation

Detector: Flame ionization detector (FID)

GC temperature rising condition: After holding for 3 minutes at 45° C., the temperature is raised up to 100° C. at a rate of 8° C./min.

GC introduction temperature: 150° C.

A sample having a different methanol concentration was similarly measured. A peak area of the solvent in a GC chart obtained in each measurement was calculated, and the solvent concentration and the peak area were plotted to obtain a calibration curve of methanol. Similarly, a calibration curve of dichloromethane was also prepared.

(2) Measurement of Residual Solvent Amount of Retardation Film

Measurement is conducted by heating under head-space heating condition in the same manner as in the procedure (1) except that the retardation film cut out in 10 cm square is fine-cut into film pieces having a size of about 5 mm and the film pieces are placed in a vial for exclusive use and the vial is sealed, and the produced volatile component is measured by gas chromatography.

The peak area of each solvent was calculated from the obtained chart and the amount of each residual solvent in the film was obtained by collating the peak area with the calibration curve obtained in the procedure (1). The amount of the residual solvent in the film was obtained as a mass rate (mass %) based on the whole film.

(Weight Change Ratio)

The obtained film was cut out in 25 cm square to prepare a sample film. A weight of the sample film (weight before storage) was measured at 23° C. and 55% RH. Next, the sample film was placed in a thermostatic chamber and stored under the conditions of 80° C. and 90% RH for 120 hr or 300 hr. Then, the sample film was taken out from the thermostatic chamber, and left at 23° C. and 55% RH for 12 hours. Thereafter, a weight of the sample film (weight after storage) was measured at 23° C. and 55% RH.

The weight of the sample film before storage and the weight of the sample film after storage were applied to the following Formula respectively to calculate weight change ratios (%).

weight change ratio (%) after and before storage=(weight after storage−weight before storage)/(weight before storage)×100

The evaluation results of the obtained films are shown in Table 3.

TABLE 3

| | | | | | | | content | | |
|---|---|---|---|---|---|---|---|---|---|
| | | cellulose ester | | | | | (mass ratio | drying condition | |
| | film | | degree of | logIv/ | | | of additive | temperature | time |
| | No. | kind | substitution | logMw | additive 1 | additive 2 | 1/additive 2) | (° C.) | (min) |
| Example 1 | 101 | A | 2.4 | 0.73 | TPP | — | 10/0 | 110 | 11 |
| Example 2 | 102 | A | 2.4 | 0.73 | TPP | — | 10/0 | 120 | 13 |
| Example 3 | 103 | A | 2.4 | 0.73 | TPP | — | 10/0 | 110 | 12 |
| Example 4 | 104 | A | 2.4 | 0.73 | TPP | — | 10/0 | 100 | 8 |
| Example 5 | 105 | A | 2.4 | 0.73 | polyester | — | 10/0 | 120 | 13 |
| Example 6 | 106 | A | 2.4 | 0.73 | TPP | polyester | 4/6 | 120 | 13 |
| Example 7 | 107 | D | 2.39 | 0.82 | TPP | polyester | 4/6 | 120 | 14 |
| Example 8 | 108 | E | 2.39 | 0.67 | TPP | polyester | 4/6 | 120 | 13 |
| Example 9 | 109 | F | 2.2 | 0.73 | TPP | polyester | 4/6 | 125 | 13 |
| Example 10 | 110 | H | 2.4 | 0.8 | TPP | polyester | 4/6 | 120 | 13 |
| Example 11 | 111 | G | 2.4 | 0.76 | TPP | polyester | 4/6 | 110 | 11 |
| Example 12 | 112 | A | 2.4 | 0.73 | TPP | polyester | 4/6 | 120 | 15 |
| Example 13 | 113 | A | 2.4 | 0.73 | TPP | polyester | 4/6 | 120 | 10 |
| Comparative | 114 | A | 2.4 | 0.73 | TPP | — | 10/0 | 130 | 15 |
| Example 1 | | | | | | | | | |
| Comparative | 115 | I | 2.41 | 0.55 | TPP | — | 10/0 | 110 | 12 |
| Example 2 | | | | | | | | | |
| Comparative | 116 | J | 2.38 | 0.99 | TPP | polyester | 4/6 | 110 | 12 |
| Example 3 | | | | | | | | | |
| Comparative | 117 | B | 2.6 | 0.7 | TPP | — | 10/0 | 110 | 12 |
| Example 4 | | | | | | | | | |
| Comparative | 118 | C | 1.8 | 0.74 | TPP | — | 10/0 | 110 | 15 |
| Example 5 | | | | | | | | | |
| Comparative | 119 | A | 2.4 | 0.73 | PETB | — | 10/0 | 110 | 12 |
| Example 6 | | | | | | | | | |
| Comparative | 120 | A | 2.4 | 0.73 | triazine | — | 10/0 | 11 | 12 |
| Example 7 | | | | | compound | | | | |

| | | amount of the residual solvent (mass | | | weight change ratio | |
|---|---|---|---|---|---|---|
| | film | ppm) | | | at 80° C. and 90% RH | |
| | thickness | total | | | after 120 | after 300 |
| | (μm) | amount | dichloromethane | methanol | hr (%) | hr (%) |
| Example 1 | 60 | 1300 | 1050 | — | −0.03 | −4.5 |
| Example 2 | 60 | 900 | 700 | 200 | −0.1 | −3.5 |
| Example 3 | 60 | 1300 | 1050 | 250 | 0.13 | −3.1 |
| Example 4 | 60 | 2000 | 1600 | 400 | 0.4 | −3 |
| Example 5 | 60 | 900 | 700 | 200 | 0.18 | −2.8 |
| Example 6 | 60 | 900 | 700 | 200 | −0.05 | −2.9 |
| Example 7 | 60 | 900 | 670 | 230 | −0.05 | −2.9 |
| Example 8 | 60 | 900 | 720 | 180 | 0.05 | −2.4 |
| Example 9 | 60 | 900 | 680 | 220 | −0.3 | −3.1 |
| Example 10 | 60 | 900 | 720 | 180 | 0.05 | −2.4 |
| Example 11 | 60 | 1300 | 1050 | — | 0.05 | −4.1 |
| Example 12 | 80 | 1000 | 800 | 200 | −0.01 | −2.7 |
| Example 13 | 45 | 800 | 700 | 100 | −0.1 | 3 |
| Comparative | 60 | 500 | 400 | — | −0.7 | −4.7 |
| Example 1 | | | | | | |
| Comparative | 60 | 1300 | 1050 | — | 0.75 | −2.3 |
| Example 2 | | | | | | |
| Comparative | 60 | 1300 | 1050 | — | 0.48 | −3.1 |
| Example 3 | | | | | | |
| Comparative | 60 | 1300 | 1050 | — | 1.2 | 0.2 |
| Example 4 | | | | | | |
| Comparative | 60 | 1300 | 1000 | — | −1.1 | −4.9 |
| Example 5 | | | | | | |
| Comparative | 60 | 1300 | 1050 | — | −0.7 | −4.2 |
| Example 6 | | | | | | |
| Comparative | 60 | 1300 | 1050 | — | −0.08 | −4.1 |
| Example 7 | | | | | | |

As shown in Table 3, the retardation films of Examples 1 to 13 including (1) a cellulose ester having a branching degree in a predetermined range and (2) a glass-transition-temperature lowering agent and (3) having an amount of the residual solvent in a predetermined range have a small weight change ratio after and before storage under high temperature and high humidity conditions, which suggests that the retardation films are less likely to swell when immersed in the saponifying solution. Meanwhile, the retardation films of Comparative Examples 1 to 7 which do not satisfy at least one of the above (1) to (3) have a large weight change ratio after and before storage under high temperature and high humidity conditions, which suggests that the retardation films are prone to swell when immersed in the saponifying solution.

Among the foregoing, it is considered that since the retardation film of Comparative Example 1 has a small amount of the residual solvent, the retardation film is prone to absorb water, which causes an increase in the weight change ratio. It is considered that since the retardation film of Comparative Example 2 has a low branching degree of a cellulose ester; for example, does not have the matrix structure having a crosslinking point but has a more linear structure, the retardation film is prone to swell when the retardation film takes in water between cellulose ester molecules. It is considered that since the retardation film of Comparative Example 6 does not include a glass-transition-temperature lowering agent having an SP value in a predetermined range, the retardation film is prone to absorb water.

### 4. Production of Polarizing Plate

### Example 14

### Production of Polarizer

A polyvinyl alcohol film having a thickness of 125 μm was uniaxially stretched at temperature of 110° C. and a stretch ratio of 5 times. The film thus obtained was immersed in an aqueous solution containing 0.075 g of iodine, 5 g of potassium iodide, and 100 g of water for 60 seconds, and then was immersed in an aqueous solution at 68° C. containing 6 g of potassium iodide, 7.5 g of boric acid, and 100 g of water. The film thus obtained was washed with water and then dried, and thus a polarizer having a thickness of 25 μm was obtained.

Production of Polarizing Plate 201

Polarizing plate 201 was produced according to the following steps 1 to 5.

Step 1: Film 101 obtained in Example 1 was immersed in a 2 mol/L sodium hydroxide solution at 60° C. for 30 seconds and then washed with water and dried to subject the surface to saponification treatment. Similarly, the surface of Konica Minolta TAC KC4UY (a cellulose ester film manufactured by Konica Minolta Opto, Inc., a thickness of 40 μm, a degree of substitution of acetyl groups of 2.89) was subjected to saponification treatment.

Step 2: The polarizer produced as described above was immersed in a polyvinyl alcohol adhesive having a solid content of 2 mass % for 1 to 2 seconds.

Step 3: Excess adhesive attached to the surface of the polarizer was gently wiped off. Then, film 101 subjected to saponification treatment was disposed on one surface of the polarizer, and Konica Minolta TAC KC4UY subjected to saponification treatment was disposed on the other surface, to obtain a laminate.

Step 4: The laminates obtained in the step 3 were pasted together at a pressure of 20 N/cm² to 30 N/cm² and a conveyance speed of about 2 m/minute.

Step 5: The laminates pasted together were dried at 80° C. for 2 minutes in a dryer, to obtain polarizing plate 201.

### Examples 15 to 26 and Comparative Examples 8 to 14

Polarizing plates 202 to 220 were obtained in the same manner as in Example 14 except that films 102 to 120 obtained in Examples 2 to 13 and Comparative Examples 1 to 7 were used in place of film 101 obtained in Example 1.

### Example 27

A PVA layer was applied and formed on a base film by the method described in Japanese Patent No. 4691205. Specifically, a PVA powder having a degree of polymerization of 1,000 or more and a degree of saponification of 99% or more was dissolved in water, to prepare a PVA aqueous solution having a concentration of 4% to 5%. The PVA solution was applied on an amorphous PET film (base film), and then dried to form the PVA layer, and thereby laminate a was obtained (polarizer layer formation step). Obtained laminate a was stretched to 1.8 times at 130° C. to prepare laminate b (in-air stretching promoting step). Obtained laminate b was immersed in a dyeing solution including water and 0.3 mass % of iodine and 2.1 mass % of potassium iodide dissolved therein, and having a solution temperature of 30° C. for 60 seconds, to obtain dyed laminate c (dyeing step). Dyed laminate c was stretched in a boric acid aqueous solution including 4 mass % of boric acid and 5 mass % of potassium iodide and having a solution temperature of 65° C. so that the total stretch ratio was 5.0 times (in-boric-acid-solution stretching step). Thereby, laminate d including the base film and the PVA layer having a thickness of 9 μm was obtained.

The PVA layer of obtained laminate d and retardation film 106 subjected to saponification treatment and obtained in Example 6 were pasted together with a polyvinyl alcohol adhesive interposed therebetween, and the base film was then peeled to obtain a laminated film of retardation film 106 and PVA layer. Furthermore, the PVA layer of the laminated film and Konica Minolta TAC KC4UY subjected to saponification treatment were pasted together with a polyvinyl alcohol adhesive interposed therebetween to obtain polarizing plate 221.

### Examples 28 to 30

Polarizing plates 222 to 224 were obtained in the same manner as in Example 27 except that kinds of retardation films or thicknesses of PVA layers were changed as shown in Table 4.

The adhesiveness between the polarizer and the retardation film in the obtained polarizing plate was evaluated according to the following method.

(Adhesiveness)

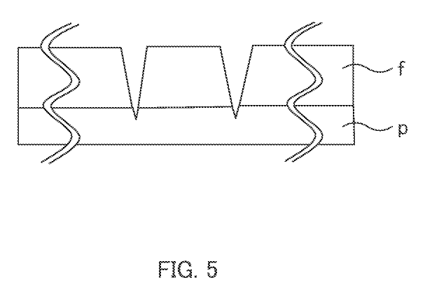

The obtained polarizing plate was cut out in 50×50 mm to prepare a sample for measurement. The sample for measurement was disposed on a sample stand of a coating film attaching strength measurement machine (SAICAS DN-EX20S type manufactured by DAIPLA WINTES CO., LTD.), and the lower surface of the sample for measurement was suctioned to fix the sample for measurement to the sample stand. Then, a range between the surface of retardation film f and a part of polarizer p was cut in the thickness direction of the sample for measurement using a V groove cutting blade having a rake angle of 5 degrees and a clearance angle of 5 degrees to form two grooves at an interval of 1.5 mm (see FIG. 5). The peel strength of the sample for measurement was measured by a surface-interface cutting method (SAICAS method).

Measurement conditions were as follows. That is, a cutting blade having a width of 1.0 mm, a rake angle of 20 degrees, and a clearance angle of 10 degrees and made of single crystal diamond was used. Cutting was carried out under the conditions of a horizontal velocity of 6 μm/second and vertical velocity of 0.5 μm/second. Specifically, cutting was carried out by moving the cutting blade at a vertical velocity of 0.5 μm/second from the surface of the retardation film to the thickness direction (perpendicular direction) of the film. Then, at the time when the cutting blade reached (cut) the interface between the retardation film and the polarizer, the vertical velocity was set to 0 μm/min; and parallel force FH (kN) was measured by moving the cutting blade in a direction parallel to the surface of the film (horizontal direction). Peel strength P (kN/m) was calculated by applying obtained parallel force FH (kN) and width w (m) of the cutting blade to the following Formula:

Peel strength P (kN/m)=FH (kN)/w (m).

The adhesiveness between the polarizer and the retardation film was evaluated according to the following criteria.

A: peel strength P of 4 or more

B: peel strength P of 2.5 or more and less than 4

C: peel strength P of 1.0 or more and less than 2.5

D: peel strength P of less than 1.0

The evaluation results of the polarizing plate are shown in Table 4.

TABLE 4

| | | | polarizer | | | |
|---|---|---|---|---|---|---|
| | polar- | retar- | film | transparent | | ad- |
| | izing | dation | thickness | protective | | hesive- |
| | plate | film | (μm) | film | F/P | ness |
| Example 14 | 201 | 101 | 25 | KC4UY | 2.4 | B |
| Example 15 | 202 | 102 | 25 | | 2.4 | B |
| Example 16 | 203 | 103 | 25 | | 2.4 | B |
| Example 17 | 204 | 104 | 25 | | 2.4 | B |
| Example 18 | 205 | 105 | 25 | | 2.4 | B |
| Example 19 | 206 | 106 | 25 | | 2.4 | A |
| Example 20 | 207 | 107 | 25 | | 2.4 | A |
| Example 21 | 208 | 108 | 25 | | 2.4 | B |
| Example 22 | 209 | 109 | 25 | | 2.4 | B |
| Example 23 | 210 | 110 | 25 | | 2.4 | B |
| Example 24 | 211 | 111 | 25 | | 2.4 | B |
| Example 25 | 212 | 112 | 25 | | 2.4 | A |
| Example 26 | 213 | 113 | 25 | | 2.4 | B |
| Example 27 | 221 | 106 | 9 | | 6.7 | A |
| Example 28 | 222 | 106 | 5 | | 12 | B |
| Example 29 | 223 | 111 | 9 | | 8.9 | A |
| Example 30 | 224 | 111 | 5 | | 16 | B |
| Comparative | 214 | 114 | 25 | | 2.4 | C |
| Example 8 | | | | | | |
| Comparative | 215 | 115 | 25 | | 2.4 | D |
| Example 9 | | | | | | |
| Comparative | 216 | 116 | 25 | | 2.4 | D |
| Example 10 | | | | | | |
| Comparative | 217 | 117 | 25 | | 2.4 | B |
| Example 11 | | | | | | |
| Comparative | 218 | 118 | 25 | | 2.4 | C |
| Example 12 | | | | | | |
| Comparative | 219 | 119 | 25 | | 2.4 | B |
| Example 13 | | | | | | |
| Comparative | 220 | 120 | 25 | | 2.4 | B |
| Example 14 | | | | | | |

As shown in Table 4, it is clear that the adhesiveness between the polarizer and the retardation film in the polarizing plates of Examples 14 to 26 is higher than that in the polarizing plates of Comparative Examples 8 to 10 and 12.

Particularly, it is considered that since the retardation film used in Comparative Example 8 has a small amount of the residual solvent, a sufficient amount of boron compound cannot be present at the adhesion interface between the polarizer and the retardation film, which causes a decrease in the adhesiveness. It is considered that since the retardation film used in Comparative Example 9 has a low branching degree of the cellulose ester, the additive is prone to move to the surface of the film, which cannot sufficiently activate the cellulose ester of the surface of the film.

It is clear that the polarizer layer and the retardation film are satisfactorily adhered to each other without causing warpage in the polarizing plates of Examples 27 to 30 obtained through a step of applying and forming the PVA aqueous solution on the retardation film. It is considered that the warpage of the polarizing plate is suppressed since the retardation films used in Examples 27 to 30 are less likely to swell in the PVA aqueous solution.

### 5. Production of Liquid Crystal Display Device

### Example 31

BRAVIA KDL40V5 manufactured by SONY Corporation was prepared as a liquid crystal display device. In liquid crystal cell A included in the liquid crystal display device, a color filter is provided on a second transparent substrate different from a first transparent substrate provided with a thin film transistor (see FIG. 2). A counter electrode is provided on the first transparent substrate; and a liquid crystal layer includes liquid crystal molecules having positive dielectric constant anisotropy. A pair of polarizing plates previously pasted on both the sides of liquid crystal cell A were removed and produced polarizing plates 201 were respectively pasted on both the surfaces of the liquid crystal cell to obtain liquid crystal display device 301. The aperture ratio of liquid crystal display device 301 was 52%.

The polarizing plate 201 and liquid crystal cell were pasted together so that film 101 was brought into contact with the liquid crystal cell, and the direction of the absorption axis of the polarizer of polarizing plate 201 is the same as that of the absorption axis of the polarizing plate previously pasted.

### Examples 32 to 47 and Comparative Examples 15 to 21

Liquid crystal display devices 302 to 324 were obtained in the same manner as in Example 27 except that a pair of polarizing plates to be pasted on both the surfaces of liquid crystal cell A was changed as shown in Table 5.

### Example 48

BRAVIA KDL-46HX800 manufactured by SONY Corporation was prepared as a liquid crystal display device. Liquid crystal cell B included in the liquid crystal display device has a COA structure where a color filter is provided on a transparent substrate provided with a thin film transistor (see FIG. 1). A counter electrode is provided on a first transparent substrate; and a liquid crystal layer includes liquid crystal molecules having positive dielectric constant anisotropy. A pair of polarizing plates previously pasted on both the sides of liquid crystal cell B was removed and produced polarizing plates 201 were respectively pasted on both the surfaces of the liquid crystal cell to obtain liquid crystal display device 325. The aperture ratio of liquid crystal display device 325 was 67%.

### Examples 49 and 50 and Comparative Examples 22 and 23

Liquid crystal display devices 326 to 329 were obtained in the same manner as in Example 42 except that a pair of polarizing plates to be pasted on both the surfaces of liquid crystal cell B was changed as shown in Table 5.

The color shift resistance of the obtained liquid crystal display device was measured by the following two methods.

Color Shift Resistance 1 (Visual Observation)

A color chart image was displayed on the obtained liquid crystal display device at 23° C. and 55% RH. Then, the liquid crystal display device was stored at 60° C. and 90% RH for 1,500 hours. Then, a color chart image was displayed at 23° C. and 55% RH on the liquid crystal display device after storage. The color shifts (color tone variations) of the liquid crystal display device after and before storage were compared with each other by visual observation. The color shift resistance was evaluated according to the following criteria.

A: No color unevenness was noticed in the liquid crystal display device before storage and the liquid crystal display device after storage.

B: Color unevenness was not substantially noticed in the liquid crystal display device before storage and the liquid crystal display device after storage.

C: Color unevenness in specific color display was slightly noticed in the liquid crystal display device before storage and the liquid crystal display device after storage, which was practically non-problematic.

D: Strong color shift and color unevenness were noticed in the liquid crystal display device before storage and the liquid crystal display device after storage, which provided practically problematic quality.

Color Shift Resistance 2 (Measurement of Hue Variation)

The obtained liquid crystal display device was stored at 60° C. and 90% RH for 1,500 hours. Hue variation when the liquid crystal display device after storage was in a black-mode state at 23° C. and 55% RH was measured using a measurement machine (EZ-Contrast 160D manufactured by ELDIM Co.).

The coordinate of hue observed in the direction of normal line to the display screen was displayed on a CIE1931 xy chromaticity diagram. A maximum distance Δxy (maximum hue variation width) between the coordinate (x, y)=(0.313, 0.34) of a neutral hue when assuming that the neutral hue was a D65 light source and the coordinate of the measured hue in the xy chromaticity diagram was calculated. The color shift resistance was evaluated according to the following criteria.

A: Δxy value was less than 0.05.

B: Δxy value was 0.05 or more and less than 0.07.

C: Δxy value was 0.07 or more and less than 0.09.

D: Δxy value was 0.09 or more.

The evaluation results obtained as described above are shown in Table 5.

TABLE 5

| | | | | | | second | | | | |
|---|---|---|---|---|---|---|---|---|---|---|
| | | first polarizing plate | | | | polarizing plate | | | | |
| | display device | (backlight side) | | | liquid | (visible side) | | | color shift | |
| | No. | No. | F1 | F2 | crystal cell | No. | F3 | F4 | visual observation | Δxy |
| Example 31 | 301 | 201 | KC4UY | 101 | A | 201 | 101 | KC4UY | B | B |
| Example 32 | 302 | 202 | | 102 | A | 202 | 102 | | B | B |
| Example 33 | 303 | 203 | | 103 | A | 203 | 103 | | B | B |
| Example 34 | 304 | 204 | | 104 | A | 204 | 104 | | B | B |
| Example 35 | 305 | 205 | | 105 | A | 205 | 105 | | B | B |
| Example 36 | 306 | 206 | | 106 | A | 206 | 106 | | A | A |
| Example 37 | 307 | 207 | | 107 | A | 207 | 107 | | A | A |
| Example 38 | 308 | 208 | | 108 | A | 208 | 108 | | B | B |
| Example 39 | 309 | 209 | | 109 | A | 209 | 109 | | B | B |
| Example 40 | 310 | 210 | | 110 | A | 210 | 110 | | B | B |
| Example 41 | 311 | 211 | | 111 | A | 211 | 111 | | B | B |
| Example 42 | 312 | 212 | | 112 | A | 212 | 112 | | A | A |
| Example 43 | 313 | 213 | | 113 | A | 213 | 113 | | B | B |
| Example 44 | 321 | 221 | | 106 | A | 221 | 106 | | A | A |
| Example 45 | 322 | 222 | | 106 | A | 222 | 106 | | B | B |
| Example 46 | 323 | 223 | | 111 | A | 223 | 111 | | A | A |
| Example 47 | 324 | 224 | | 111 | A | 224 | 111 | | B | B |
| Comparative Example 15 | 314 | 214 | | 114 | A | 214 | 114 | | C | C |
| Comparative Example 16 | 315 | 215 | | 115 | A | 215 | 115 | | D | D |
| Comparative Example 17 | 316 | 216 | | 116 | A | 216 | 116 | | C | D |
| Comparative Example 18 | 317 | 217 | | 117 | A | 217 | 117 | | C | C |
| Comparative Example 19 | 318 | 218 | | 118 | A | 218 | 118 | | C | D |
| Comparative Example 20 | 319 | 219 | | 119 | A | 219 | 119 | | C | C |
| Comparative Example 21 | 320 | 220 | | 120 | A | 220 | 120 | | C | D |
| Example 48 | 325 | 201 | KC4UA | 101 | B | 201 | 101 | KC4UA | B | B |
| Example 49 | 326 | 202 | | 102 | B | 202 | 102 | | B | B |
| Example 50 | 327 | 206 | | 106 | B | 206 | 106 | | A | A |
| Comparative Example 22 | 328 | 214 | | 114 | B | 214 | 114 | | D | D |
| Comparative Example 23 | 329 | 215 | | 115 | B | 215 | 115 | | D | D |

As shown in Table 5, it is clear that the liquid crystal display devices of Examples 31 to 47 have a higher color shift resistance than that of the liquid crystal display devices of Comparative Examples 15 to 21. Similarly, it is clear that the liquid crystal display devices of Examples 48 to 50 have a higher color shift resistance than that of the liquid crystal display devices of Comparative Examples 22 and 23.

Particularly, it is clear that the liquid crystal display devices of Examples 48 to 50 using the retardation film of the present invention have a COA structure, but the liquid crystal display devices have color shift satisfactorily suppressed.

### INDUSTRIAL APPLICABILITY

The retardation film of the present invention swells only a little when immersed in a saponifying solution and has good adhesiveness to a polarizer, even though the film includes cellulose acetate having a low degree of substitution of acyl groups.

### REFERENCE SIGNS LIST

10, 10′ liquid crystal display device
11, 21 oriented film
30, 30′ liquid crystal cell
50 first polarizing plate
51 first polarizer
53 protective film (F1)
55 protective film (F2)
70 second polarizing plate
71 second polarizer
73 protective film (F3)
75 protective film (F4)
90 backlight
100, 100′ array substrate
110, 210 transparent substrate
120 thin film transistor
130 color filter
124a gate electrode
140 gate insulator film
154a island semiconductor
163a first island ohmic contact member
165a second island ohmic contact member
171a, 171b data line
173a, 173b source electrode
175a drain electrode
180p lower protective membrane
180q upper protective membrane
191a pixel electrode (pixel electrode)
191b pixel electrode (counter electrode)
200, 200′ counter substrate
225a through-hole
227 opening part of light blocking member 220
270 common electrode
300 liquid crystal layer

1. A retardation film comprising:
a cellulose ester having a total degree of substitution of acyl groups of 2.0 to 2.55 and a slope of a plot of 0.65 to 0.85, the plot being obtained by plotting a common logarithm log [Mw(a)] of an absolute molecular weight Mw(a) on an abscissa axis versus a common logarithm log [Iv(a)] of an intrinsic viscosity Iv(a) on an ordinate axis, through GPC-LALLS-viscosity measurement; and
a glass-transition-temperature lowering agent having an SP value of 9.0 to 11.0,
wherein an amount of a residual solvent in the retardation film is 700 mass ppm to 3,000 mass ppm; and
a weight change ratio represented by the following formula:
weight change ratio (%)=(M1−M0)/M0×100
is −0.5% to 0.5%, where a weight of the retardation film before storage at 80° C. and 90% RH is defined as M0 and a weight of the retardation film after storage at 80° C. and 90% RH for 120 hours is defined as M1.

2. The retardation film according to claim 1, wherein all of the acyl groups included in the cellulose ester are an acetyl group.

3. The retardation film according to claim 1, wherein the residual solvent in the retardation film contains dichloromethane and methanol.

4. The retardation film according to claim 1, wherein the glass-transition-temperature lowering agent is a phosphoric acid ester compound or a polyester compound.

5. The retardation film according to claim 1, wherein a weight change ratio represented by the following formula:
weight change ratio (%)=(M2−M0)/M0×100
is −2% to −4%, where a weight of the retardation film after storage at 80° C. and 90% RH for 300 hours is defined as M2.

6. The retardation film according to claim 1, wherein the retardation film is a wound body wound in a direction perpendicular to a width direction of the film.

7. A method for producing a polarizing plate comprising a polarizer and a retardation film according to claim 1, wherein the polarizing plate satisfies both the following Formulas (a) and (b):
40≦F≦100 (a)
6≦F/P≦16, (b)
where a thickness of the polarizer is defined as P (μm) and a thickness of the retardation film is defined as F (μm).

8. A liquid crystal display device comprising:
a liquid crystal cell;
a first polarizing plate disposed on a surface of the liquid crystal cell and including a first polarizer; and
a second polarizing plate disposed on the other surface of the liquid crystal cell and including a second polarizer,
wherein the liquid crystal cell includes an array substrate including a thin film transistor, a counter substrate, and a liquid crystal layer disposed between the array substrate and the counter substrate and including liquid crystal molecules;
the liquid crystal cell is such that the liquid crystal molecules are oriented perpendicularly to a surface of the array substrate when no voltage is applied and the liquid crystal molecules are oriented horizontally to the surface of the array substrate when a voltage is applied; and
the first polarizing plate has a retardation film according to claim 1 provided on a surface of the first polarizer facing the liquid crystal cell, or
the second polarizing plate has the retardation film according to claim 1 provided on a surface of the second polarizer facing the liquid crystal cell.

9. A liquid crystal display device comprising:
a liquid crystal cell;
a first polarizing plate disposed on a surface of the liquid crystal cell and including a first polarizer; and
a second polarizing plate disposed on the other surface of the liquid crystal cell and including a second polarizer,
wherein the liquid crystal cell includes an array substrate including a thin film transistor, a counter substrate, and a liquid crystal layer disposed between the array substrate and the counter substrate and including liquid crystal molecules;
the liquid crystal cell is such that the liquid crystal molecules are oriented perpendicularly to a surface of the array substrate when no voltage is applied and the liquid crystal molecules are oriented horizontally to the surface of the array substrate when a voltage is applied; and
the first polarizing plate is obtained by a method according to claim 7, and a retardation film of the first polarizing plate is disposed on a surface of the first polarizer facing the liquid crystal cell, or
the second polarizing plate is obtained by a method according to claim 7, and a retardation film of the second polarizing plate is disposed on a surface of the second polarizer facing the liquid crystal cell.

10. The liquid crystal display device according to claim 8, wherein the array substrate of the liquid crystal cell further includes a color filter.
